(19) United States
(12) Patent Application Publication
(10) Pub. No.: US 2025/0219178 A1
(43) Pub. Date: Jul. 3, 2025

(54) MULTI-DIMENSION, MULTI-MODE CHROMATOGRAPHY METHODS FOR PRODUCING HIGH PURITY, HIGH YIELD LITHIUM, COBALT, NICKEL, AND MANGANESE SALTS FROM WASTE LITHIUM-ION BATTERIES AND OTHER FEEDSTOCKS

(71) Applicant: Purdue Research Foundation, West Lafayette, IN (US)

(72) Inventors: Nien-Hwa Linda Wang, West Lafayette, IN (US); Yi Ding, West Lafayette, IN (US); Gabriel Perez Schuster, West Lafayette, IN (US)

(21) Appl. No.: 18/850,894

(22) PCT Filed: Mar. 24, 2023
(86) PCT No.: PCT/US23/64963

§ 371 Date: Sep. 25, 2024

Related U.S. Application Data
(60) Provisional application No. 63/323,755, filed on Mar. 25, 2022.

(51) Int. Cl. H01M 10/54; C22B 3/00; C22B 3/22; C22B 3/42; C22B 7/00; C22B 26/12; C22B 47/00

(52) U.S. Cl. CPC H01M 10/54; C22B 3/22; C22B 3/42; C22B 7/005; C22B 7/007; C22B 23/0453; C22B 26/12; C22B 47/00

(57) ABSTRACT

A versatile and efficient method is described for recovering a high-purity material (target) or multiple materials (targets) from a complex mixture in batch or continuous chromatography systems. If perfectly selective sorbents are available for the targets, constant-pattern batch capture methods in tandem or tandem carousel capture methods are preferred. If perfectly selective sorbents for the targets are unavailable, the batch capture, carousel capture, isocratic SMB, non-isocratic SMB, and isotachic displacement methods can be deployed in tandem or in parallel to produce high purity products with high yields and high productivity.

### CROSS-REFERENCE TO RELATED APPLICATIONS

This patent application claims priority to U.S. Provisional Patent Application Ser. No. 63/323,755, filed on Mar. 27, 2022, the entirety of which is incorporated herein by reference.

### TECHNICAL FIELD

The present novel technology relates generally to the field of chromatography and, more particularly, to a chromatographic method of recovering component elements from waste lithium ion batteries (LIBs) and other lithium feedstocks.

### BACKGROUND

The market share of electric vehicles (EVs) has been increasing rapidly in recent years, driven by the need to reduce carbon emissions and pollution associated with conventional vehicles powered by fossil fuels. Lithium (Li), cobalt (Co), nickel (Ni), and manganese (Mn) are four essential elements in the cathode materials found in lithium-ion batteries (LIBs), which are needed to power the EVs, for energy storage, and to power electronic devices. Demand for the batteries is expected to increase eightfold by 2030. The global reserves of extractable Co, 7.1 million tons, are projected to be mostly depleted by 2035. The global reserve of extractable Li, 12-14 million tons, is projected to be depleted by more than 50% by 2035. Recycling Li, Co, Ni, and Mn in the LIBs is critical for a circular economy and a sustainable clean energy future.

Current pyrometallurgical methods require a high temperature (>1400° C.) to reduce the mixed metal oxides to alloys of Co and Ni. These alloys require further processing to produce pure metals. Li and Mn cannot be reduced, are collected in the slag, and are not recovered. These methods have a high capital cost, high energy consumption, and high green house gas (GHG) emissions.

Hydrometallurgical methods use organic and/or inorganic acid leaching to convert the metal oxides in the cathode materials into soluble salts. The metal ions can be purified using sequential selective precipitation or multistage solvent extraction methods. Selective precipitation methods, however, cannot produce high purity (>99%) salts with high yields (>95%), because of co-precipitation of the various salts resulting from imprecise control of the local solution pH. Solvent extraction methods require flammable solvents and multiple stages to achieve high purity products, resulting in high chemical, capital, and waste treatment costs. Current pyrometallurgical, hydrometallurgical, and/or sulfidation methods cannot produce high-purity (>99.5%) Li, Co, Ni, and Mn with high yield (>99%) from the cathode materials derived from LIBs. Thus, there remains a need for an improved method of recovering Li, Co, Ni, and Mn from waste LIBs. The present novel technology addresses this need.

### SUMMARY

New chromatography methods are invented for producing high-purity (99.5%) lithium, cobalt, nickel, and manganese salts with high yields (99%) from waste lithium-ion batteries and other feedstocks. These new methods require relatively low temperature processing and have low GHG emissions. The novel methods are based on intrinsic (scale-independent) engineering parameters, which allow the processes to be easily scaled from lab scale to pilot scale, to commercial production scale. The instant novel methods are more efficient and thus more economical than the conventional extraction and purification methods. Most of the chemicals can be recycled and little waste are generated. The high-purity products enable versatile utilization of the critical materials recovered from waste LIBs and other feedstocks.

### DESCRIPTION OF THE DRAWINGS

FIG. 1A graphically illustrates an unsustainable linear path of critical materials.

FIG. 1B graphically illustrates methods to enable sustainable circular economy of critical materials for lithium-ion batteries

FIG. 2A is a Sherwood plot for various metal elements.

FIG. 2B graphically illustrates estimated production costs (thick best-fit correlation line) for producing pure Li or Co from conventional sources (brines and minerals) and from waste LIBs.

FIG. 3 graphically illustrates the three different modes of interaction arising from the instant novel technology.

FIG. 4A is a block flow diagram for the application of the instant novel chromatography methods for producing high-purity Li, Co, Ni, and Mn salts.

FIG. 4B diagrammatically illustrates a model simulation of the dynamics of reaction and separation in the instant chromatography system.

FIG. 4C diagrammatically illustrates a four-zone simulated moving bed chromatography system having eight operationally connected columns.

FIG. 5A is a diagrammatic representation of a batch scale capture process according to one embodiment of the present novel technology.

FIG. 5B graphically illustrates concentration dynamic profiles in a single column capture process according to one embodiment of the present novel technology.

FIG. 6A graphically illustrates the correlation between dimensionless column length and dimensionless intraparticle diffusion rate.

FIG. 6B block diagrammatically illustrates the constant pattern design method for single-column capture.

FIG. 7 block diagrammatically illustrates a process for producing a mixture of Li, Mn, Co, Ni salts from black mass.

FIG. 8 graphically illustrates the tandem capture process for producing high-purity individual elements from NMC cathode leaching solutions.

FIG. 9A graphically illustrates a three-column carousel process according to one embodiment of the present novel technology.

FIG. 9B graphically illustrates the first cycle of a four-segment carousel process according to one embodiment of the present novel technology.

FIG. 9C is a chart illustrating concentration waves as a function of normalized column position in the first two segments of a carousel.

FIG. 10A graphically illustrates a column concentration dynamic profiles for displacement chromatography according to one embodiment of the present novel technology.

FIG. 10B graphically illustrates displacement chromatography.

FIG. 11 graphically illustrates a displacement chromatography process according to one embodiment of the present novel technology.

FIG. 12 graphically illustrates a displacement to produce high purity Li, Mn, Co, and Ni from LIB cathodes using Li as the presaturant and Ni as the displacer according to one embodiment of the present novel technology.

FIG. 13 block diagrammatically illustrates a flow chart for constant pattern design method when the yield is specified

FIG. 14 block diagrammatically illustrates a flow chart for constant pattern design method to achieve maximum productivity when the purity requirement is specified.

FIG. 15A graphically illustrates the configuration of a four-zone SMB having four pumps and Li-selective sorbents.

FIG. 15B graphically illustrates the configuration of an open-loop, three-zone SMB having three pumps and Li-selective sorbents.

FIG. 15C graphically illustrates the configuration of a four-zone SMB for splitting a terniary mixture.

FIG. 15D graphically illustrates the configuration of a four-zone SMB having four pumps for splitting a four-component mixture.

FIG. 15E graphically illustrates the configuration of a four-zone SMB for binary splitting an N-component mixture into two products.

FIG. 15F graphically illustrates the configuration of an eight-zone SMB having eight pumps.

FIG. 15G graphically illustrates the configuration of a six-zone SMB having six pumps.

FIG. 15H graphically illustrates the configuration of a simplified six-zone SMB having four pumps.

FIG. 16 graphically illustrates simulated effluent history of capturing impurities from leaching solution derived from black mass.

FIG. 17 graphically illustrates simulated effluent history of producing high-purity Li from Mg/Li binary mixture.

FIG. 18 graphically illustrates capture of Mn from a mixture of Li, Co, Ni, and Mn in a Purolite MTX7010 column.

FIG. 19 graphically illustrates capture of Co in Purolite MTX8010 column.

FIG. 20 graphically illustrates effluent history of Ni capture using an IDA column.

FIG. 21A graphically illustrates simulated effluent history at the end of a second segment.

FIG. 21B graphically illustrates column dynamic concentration profiles before the feed port switching.

FIG. 22A graphically illustrates a tandem carousel and fractionation chromatography system according to one embodiment of the present novel technology.

FIG. 22B graphically illustrates a tandem carousel and fractionation chromatography system according to another embodiment of the present novel technology.

FIG. 23 graphically illustrates simulated effluent history for producing high-purity LiOH.

FIG. 24 graphically illustrates experimental and simulated effluent history for converting LiSO₄ into LiOH using anion exchange

FIGS. 25A-C graphically illustrate effluent history of several displacement examples.

FIG. 26 graphically illustrates effluent histories as given in example 6.1.

FIG. 27 graphically illustrates effluent histories of pH and metal ions as given in Example 6.2.

FIG. 28 graphically illustrates effluent histories of pH and metal ions as given in Example 6.3.

FIG. 29 block diagrammatically illustrates a process for pilot testing of Li recovery

FIG. 30 graphically illustrates experimental and simulated effluent histories of the pilot testing of Li recovery.

FIGS. 31A-B graphically illustrate concentration as a function of time for extract (31A) and raffinate (31B).

FIG. 32A graphically illustrates concentration as a function of normalized column position for a simulated column dynamic profile at the starting step.

FIG. 32B graphically illustrates concentration as a function of normalized column position for a simulated column dynamic profile at the ending step.

FIGS. 33A-F graphically illustrate on SMB cycle of Example 9.

FIGS. 34A-C graphically illustrate effluent histories and column profile at steady state of Example 9.

### DETAILED DESCRIPTION

For the purposes of promoting an understanding of the principles of the instant novel technology and presenting its currently understood best mode of operation, reference will now be made to the embodiments illustrated in the drawings and specific language will be used to describe the same. It will nevertheless be understood that no limitation of the scope of the novel technology is thereby intended, with such alterations and further modifications in the illustrated device and such further applications of the principles of the novel technology as illustrated therein being contemplated as would normally occur to one skilled in the art to which the novel technology relates.

This invention of multidimension and multimode chromatography methods employs synergistic combinations of (1) various stationary phases with different functional groups and adsorption/desorption mechanisms, (2) various operation modes, including batch or continuous capture, displacement, and/or elution, and (3) various reactions to achieve efficient separation of complex mixtures. Specifically, the new methods include: (1) constant-pattern batch capture methods; (2) constant-pattern carousel capture methods; (3) constant-pattern tandem capture methods for producing multiple pure components from a mixture; (4) generalized displacement fractionation methods for producing multiple pure components from a mixture; and (5) general simulated moving bed methods for continuously producing high purity products from complex mixtures.

The general constant-pattern batch capture methods enable easy designs of single-column capture processes based on intrinsic adsorption and mass transfer parameters of the stationary phases and the capture target components, which can be extrapolated from small lab-scale embodiments. The instant methods can be used to achieve high capture yields and high productivity.

The constant-pattern carousel capture methods can ensure attainment of cyclic steady state, 100% resin capacity utilization, high capture yield (>99%), and high productivity of the stationary phase.

Highly-selective sorbents can be used in a series of columns connected in tandem to sequentially capture target components from a mixture. The methods can also be applied to recover high purity Li, Co, Ni, and Mn from brines or minerals.

Examples of the versatile methods are used below to show that high-purity (>99.5%) salts of Li, Co, Ni, and Mn with high yields (>99%) are produced economically from the cathode materials of waste LIBs. The new methods require relatively low temperature processing and have low GHG emissions. The design methods are based on intrinsic (scale-independent) engineering parameters, which allow the processes to be easily scaled from lab scale, to pilot scale, to commercial production scale. The new methods are more efficient and more economical than the conventional extraction and purification methods. Most of the chemicals can be recycled and little waste is generated. The high-purity products enable versatile utilization of the critical materials recovered from waste LIBs.

The market share of electric vehicles (EVs) has been increasing rapidly in recent years, driven by the need to reduce carbon emissions and pollution associated with conventional vehicles powered by fossil fuels. The sales of EVs have surpassed 200,000 units in 2020 in the United States and are predicted to double in less than 5 years. General Motors announced plans in 2021 to produce only EVs by 2035. Analysts predicted that 18% of all new cars worldwide will be EVs by 2030.

The key component in electric vehicles is lithium-ion batteries (LIBs). The battery pack of Tesla Model S, for example, has 7,104 LIB cells to generate 85 kWh. Each EV requires about 90 kg of Li, Co, Ni, and Mn for making the cathode materials of LIBs. LIBs have been widely used in portable electronic devices and electric vehicles over the past several decades because of their high energy density, high efficiency, high stability, and long lifespan. LIBs have a market size of nearly $3 billion in the U.S. and are predicted to increase in the future because of the booming EVs industry. Demand for batteries is expected to increase by 8 times by 2030. Average life of LIB is between 7 and 10 years.

Lithium (Li) and cobalt (Co) are the two essential elements in LIBs. About 90% of lithium and more than 50% of cobalt of the world supplies are used in LIBs. Demand for batteries is expected to increase by 8 times by 2030. The increase in the EVs market led to an increasing demand and a price surge of lithium and Co. However, the production of Co (140,000 tons/yr) is concentrated in the Democratic Republic of Congo (DRC), which controls about 70% of the world supply in 2020. The global reserve (or economically extractable supply) of Co, 7.1 million tons, is projected to be mostly depleted by 2035. The global reserve of Li, 12-14 million tons, is projected to be depleted by more than 50% by 2035. Recycling Li and Co in the LIBs is critical for a circular economy and a sustainable clean energy future.

Most (87%) of the lithium is produced currently from Li-rich brines, containing 200 to 3,000 ppm of Li. The brines are concentrated with solar evaporation to 7,000 to 10,000 ppm Li before further purification. About 13% of the lithium is produced from ores, with about 0.5 to 7 wt. % Li. Producing 1 ton of lithium would require up to 200 tons of mineral ores or up to 3,000 tons of lithium-rich brine, and 1,900 tons of water is consumed in the extraction process. However, only 28 tons of waste LIBs are needed to produce the same amount of Li materials.

Less than 10% of the Co is produced as the primary product, with over 90% produced as a byproduct of copper or nickel. About 70% of Co supply comes from the DRC. The mineral ores are crushed and ground first, followed by a high-pressure acid leaching process. Copper in the leaching solution can be recovered using electrowinning, while cobalt is separated and precipitated as hydroxide. Cobalt hydroxide can then be re-dissolved and used to produce metal product through electrolysis.

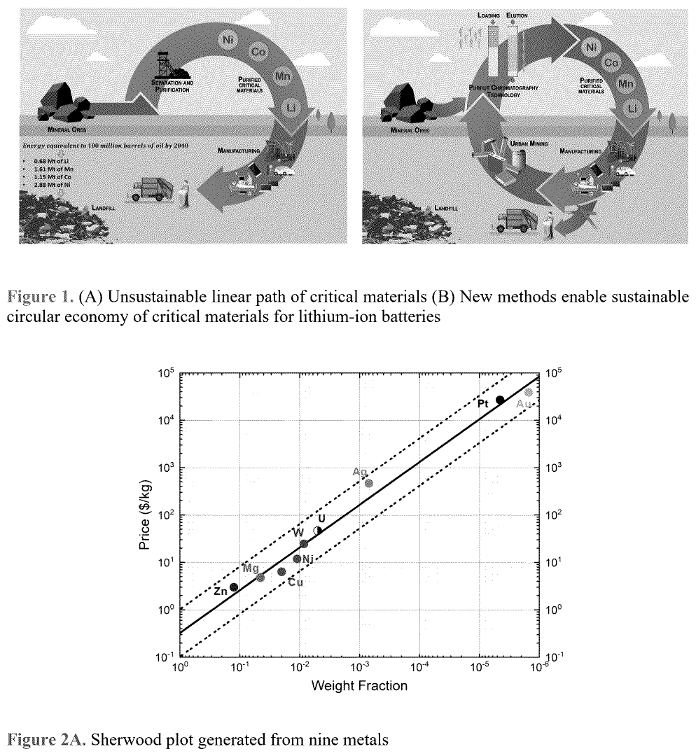

More than 50% of the world cobalt supplies are used in LIBs for electronic devices and electric vehicles. Recovering Li and Co from LIBs can reduce the supply risks, mitigate the environmental impacts associated with mining, and help achieve sustainable circular use of limited minerals (see FIG. 1). In addition, production of critical materials from waste LIBs can be more economical and energy efficient than the production from minerals or brines, as explained below.

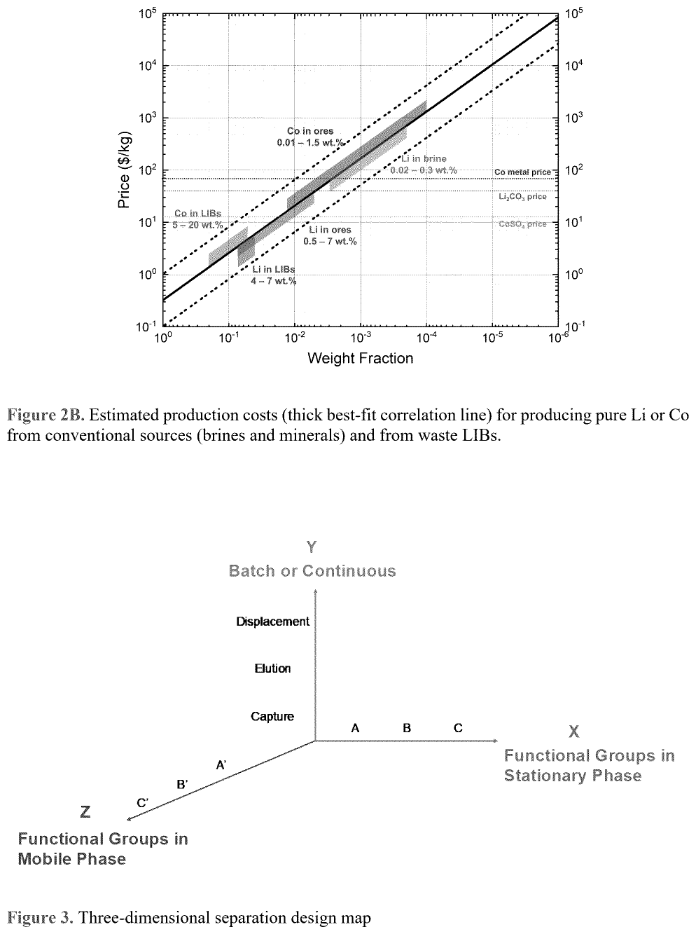

Waste LIB is a better feedstock for producing Li and/or Co than are mineral ores or brines. A crude assessment of the economic feasibility of producing a target mineral from a new feedstock is made as follows. This crude analysis is based on the general trend that the prices of products are related to the concentrations of the target products in the feedstocks. The lower the concentration of a target in the feedstock, the higher the cost of producing a high-purity target product from the feedstock. The current prices for nine pure metals (Au, Ag, Pt, Cu, Zn, Ni, Mg, U, W) are plotted against the weight fractions of the metals in the feedstocks in a log-log plot. A best-fit line with a correlation coefficient of 0.98 and a small standard deviation of 0.04 can be obtained (see FIG. 2A). Since the prices of the feedstocks are usually small compared to the prices of the pure metals, the market prices of the pure metals are usually in the same order of magnitude of their production costs.

This best-fit line for predicting the market price for producing Li from Li-rich brines is testable. The metal points in FIG. 2A are not shown in FIG. 2B for clarity. Since this best-fit line represents crude estimates of the production costs of metals, two dashed lines are added to FIG. 2B to indicate the uncertainty of the crude estimates and to consider the price differences between metals and metal salts.

Currently Li-rich brines are first concentrated by evaporating water using solar energy to >0.7% Li before further purification. Since the costs of the brines and the costs for producing the Li concentrates are negligible, we can consider the concentrates with 0.7% Li as the feedstock. The processing cost for producing pure Li metal from this feedstock according to the best line is about $30/kg, which is in the same order of magnitude as the current market price of Li₂CO₃, $40/kg.

By contrast, the costs estimated from the best-fit line for producing Li as the primary product from the Li-rich brines with 200 ppm Li are over $700/kg Li metal, indicating that the low concentration brine is not a competitive feedstock as the Li concentrates with >0.7% Li. Similar analysis indicates that producing Li from mineral ores requires ores with 0.7% or higher Li to be competitive with the current production from the Li concentrates.

The best-fit line for estimating the cost for producing Li from a nonconventional feedstock, waste LIBs, may be applied. Typical black mass (the active cathode and anode materials) derived from LIBs contain 4-7 wt. % Li, which is much higher than the Li-rich brines, the brine concentrates, and majority of the Li mineral ores. This analysis indicates that high purity Li salts can be produced from waste LIB batteries at lower costs than from brines or from the mineral ores.

In addition to Li, the black mass derived from waste LIBs also contain 5-20 wt. % Co, which are much higher than those in typical Co minerals, 0.01% to 1.5%. The estimated costs for producing Co salts from waste LIBs as the primary products are lower than the market price of Co salts, indicating profit potential. They are also significantly lower than those from minerals (see FIG. 2B), indicating that waste LIBs are potentially higher-grade “ores” for both Li and Co. If both Li and Co are produced from waste LIB's, the overall profit potential is even higher than producing Li or Co from conventional sources. Furthermore, if Ni or Mn (about 8% of the black mass from waste LIBs) are also produced as by-products from waste LIBs, the profit potential is even higher.

This analysis also indicates that in a linear critical material economy, as the high-grade minerals or brines are depleted, producing the critical materials from lower-grade feedstocks will require higher production costs and therefore higher prices of the critical materials. Recycling Li, Co, Ni, and Mn from waste LIBs potentially can prevent escalation of the prices of the critical materials and slow down the depletion of the primary feedstocks of the critical materials.

LIBs have traditionally been recycled through two routes, direct recycling and chemical recycling. The direct recycling process entails disassembling electrodes, reconditioning, and reusing the materials in the remanufacturing of LIBs. Although this method has low energy and chemical consumption, it greatly depends on the conditions of the waste batteries. It also has less flexibility when handling various electrode compositions, or in controlling the compositions of the recycled electrodes. The quality of the remanufactured LIBs cannot be guaranteed. Direct recycling has a relatively high yield of all the materials and low waste generation, but the method is complex, requires presorting, and has a high production cost. Furthermore, the recovered material from a specific type of cathode is not easily modified to produce a different type of cathode material.

The chemical route of recycling uses either pyrometallurgical or hydrometallurgical methods. Pyrometallurgical methods require high temperatures (>1,400° C.) to reduce the mixed metal oxides to alloys consisting of Co and Ni, while Li and Mn cannot be reduced and are collected in the slag. Pyrometallurgical processes are popular in industry because of simplicity and high productivity. Several companies have already commercialized this process. This process has a high capital cost and high energy consumption. The recovered materials are alloys of Ni and Co, while Li and Mn are not recovered.

Hydrometallurgical methods can be used to convert the metal oxides in LIB cathode materials with a high yield (>90%) into soluble salts by using organic or inorganic acids leaching. A reducing agent, for example, hydrogen peroxide, is usually used in the leaching process to prevent oxidation of Co(II) to insoluble Co(III) to improve the recovery yield. The metal ions in the leachate can be further purified by (1) selective or sequential precipitation; (2) solvent extraction; (3) electrodeposition; or (4) sulfidation.

In selective or sequential precipitation processes, metal ions present in the leaching solution were precipitated by adjusting pH or by adding precipitation agents such as oxalate or carbonate. These methods can achieve relatively high yields, typically greater than 95%, however, the purities of the products are usually low, typically less than 99% pure, which is unacceptable for manufacturing of LIB cathode materials. Further purification is needed before the materials can be used for manufacturing.

Solvent extraction methods can achieve higher product purity than pyrometallurgy or precipitation methods, but also require a large number of equilibrium stages (mixer/settler units) to achieve high product purities (in excess of 99%). The extractant di-(2-ethylhexyl) phosphoric acid (P204, HDEHP) is commonly used for producing high-purity Mn products, while Co is separated from Ni with 2-Ethylhexyl 2-ethylhexylphosphonic acid or the like. Lithium ions often remained in the aqueous phase in the solvent extraction process and can be precipitated as lithium carbonate. However, significant loss of Li to the organic phase occurs during the extraction of Mn, Co, and Ni. The solvent extraction methods have high capital costs and high costs for initial purchase of the solvents, and the equipment is feedstock specific.

In the electrodeposition process, concentrated chloride salt is used to form anionic cobalt chloride complex, while Ni remains as a cation species. Co and Ni are separated in the electrical field with the addition of the polymer electrolyte for tuning the selectivity. However, relatively low purities have been reported, 96.4% for Co, 94.1% for Ni. Both are recovered as mixtures of metals, which need to be oxidized and re-dissolved in a strong acid before purification.

Sulfidation method uses sulfur and sulfur dioxide to react with ground cathode materials at 1,000° C. to convert metal oxides to metal sulfides. The reaction products are separated into three immiscible liquids at the high temperature: nickel-rich sulfide, cobalt-rich sulfide, and manganese oxysulfide. Low recovery yields (<90%) are reported, and no high purity materials have been recovered. Further purification of the products is difficult since metal sulfides are insoluble even in strong (>10 M) acids.

TABLE 1
State-of-the-art separation and purification method of Li, Mn, Co, and Ni from waste LIBs

| | Leaching | | | Purity (%) | | | | Yields (%) | | | | |
|---|---|---|---|---|---|---|---|---|---|---|---|---|
| Feedstock | chemicals | PPT chemicals | Products | Li | Co | Ni | Mn | Li | Co | Ni | Mn | Comments |
| NMC | H2SO4 and | Oxalic acid for Co; | CoC2O4 | 98 | 96 | — | — | 97 | 98 | 89 | 88 | Waste: |
| | NaHSO3 | NaOH and Na2CO3 | MnCO3 | | | | | | | | | Na2SO4 |
| | | for Mn and Ni (pH 7.5 | NiCO3 | | | | | | | | | |
| | | and 9); Na2CO3 for | Li2CO3 | | | | | | | | | |
| | | Li | | | | | | | | | | |
| NMC | Oxalic acid | Oxalic acid | Li2CO3 | 97 | 0 | 0 | 0 | 81 | 0 | 0 | 0 | |
| | | | Mixed oxalate | | | | | | | | | |
| | | | for resynthesis? | | | | | | | | | |
| NMC | Phosphoric | oxalate for impurities | Li phosphate | 98 | 0 | 0 | 0 | >98 | 0 | 0 | 0 | |
| | acid | | | | | | | | | | | |
| NMC | | Ammonium persulfate | MnO2 | >99 | 97 | 98 | 97 | 90 | >99 | >99 | >99 | High |
| | | for Mn (pH 5.5 80 C. | C8H14N4NiO4 | | | | | | | | | chemical |
| | | 90 min), | Co(OH)2 | | | | | | | | | cost, toxic |
| | | Dimethylglyoxime for | Li2CO3 | | | | | | | | | chemicals, |
| | | Ni (pH 6 30 C. 20 | | | | | | | | | | waste |
| | | min), NaOH for Co | | | | | | | | | | |
| | | (pH 10) and Na2CO3 | | | | | | | | | | |
| | | for Li (90 C.) | | | | | | | | | | |

| | | | | Purity | | | | Yield | | | | |
|---|---|---|---|---|---|---|---|---|---|---|---|---|
| Feed | Leaching | Extraction chemicals | Products | Li | Co | Ni | Mn | Li | Co | Ni | Mn | Comments |
| Simulant | | Cyanex 272 | High purity Li | 99.9 | 99.6 | 99.7 | NA | — | — | — | NA | |
| Co, Ni, | | selectively extract Co | salt? High | | | | | | | | | |
| and Li | | and Ni, Scrubbing Li | purity Co in | | | | | | | | | |
| | | using NiSO4, two- | organic phase | | | | | | | | | |
| | | stage selective | and high purity | | | | | | | | | |
| | | stripping Ni from Co | NiSO4 | | | | | | | | | |
| LIBs | NaOH | P204 for Mn, P507 for | MnO2 | — | 99 | — | — | 0 | 93 | 0 | 90 | Li and Ni are |
| | pretreatment | Co, electrowinning for | Metallic Co | | | | | | | | | mixed |
| | to dissolve | Co | | | | | | | | | | |
| | Al; | | | | | | | | | | | |
| | reductive | | | | | | | | | | | |
| | acid | | | | | | | | | | | |
| | leaching for | | | | | | | | | | | |
| | Li, Ni, Mn, | | | | | | | | | | | |
| | and Co. | | | | | | | | | | | |
| NMC | 2M H₂SO₄ | Versatic 10 to extract | Li₂CO₃ | 99.6 | — | — | — | 92 | — | — | — | |
| | 0.97M | Co, Mn, Ni | | | | | | | | | | |
| | H₂O₂ | | | | | | | | | | | |

| | | | | Purity | | | | Yield | | | | |
|---|---|---|---|---|---|---|---|---|---|---|---|---|
| Feed | Conversion and separation | | Products | Li | Co | Ni | Mn | Li | Co | Ni | Mn | Comments |
| NMC | High concentration chloride | | Metallic Ni and | 0 | 96.4 | 94.1 | 0 | — | — | — | — | |
| | salt (10M LiCl); electrical field | | Co | | | | | | | | | |
| NMC | S/SO₂ 1000° C. | | Metal sulfides | 0 | 67 | 75 | 100 | — | — | — | — | High energy |
| | | | and oxides | | | | | | | | | consumption, |
| | | | | | | | | | | | | low purity, |
| | | | | | | | | | | | | further |
| | | | | | | | | | | | | purification |
| | | | | | | | | | | | | is costly |
| NMC | HCl or | HCl or H₂SO₄ | High purity | >99.9 | >99.5 | >99.5 | >99.5 | >99 | >99 | >99 | >99 | Capture |
| | H₂SO₄ H₂O₂ | | metal salts | | | | | | | | | |
| NMC | HCl or | HCl or H₂SO₄ | High purity | >99.5 | >99.5 | >99.5 | >99.5 | | | | | Displacement |
| | H₂SO₄ H₂O₂ | | metal salts | | | | | | | | | |

In summary, none of the state-of-the art literature methods can produce both high purity (>99.5%) Li, Co, Ni, and Mn with high yields (>99%) from cathode materials of LIBs.

In contrast, the novel technology described hereinbelow is based on advanced chromatography methods, which have high active surface area per unit volume. The methods have greater efficiency, greater productivity, and smaller footprints as compared to solvent extraction methods. High purity (>99.5%) materials can be produced with high yields (>99%) and high throughputs from complex mixtures derived from waste LIBs. The design methods, which are based on first principles and intrinsic parameters, are versatile and scalable, and can be applied to different feed compositions and production scales. Only room temperature is required for the purification methods, leading to high energy efficiency low energy costs, and low GHG (greenhouse gas) emissions. In addition, chemical consumption is lower than selective precipitation and extraction methods, and almost all chemicals can be recycled and reused, generating little waste. The overall processes are economical and environmentally friendly.

If the feedstock containing the critical materials of interest is a complex mixture, it is an effective strategy to produce a concentrate of the target components first. Examples include: (1) low cost physical separations by differences in particle size, particle density, or magnetic properties; (2) free solar energies for concentration via evaporation of water: (3) precipitation reactions with H+, OH, carbonate, phosphate, sulfate, oxalate, and/or chelating agents. The concentrates containing the critical materials can be purified using the instant novel chromatography methods. The most valuable components in waste LIBs are the cathode materials, which contain Li, Co, Ni, and Mn. The instant novel technology is primarily focused on the recovery of these materials from the cathode materials from LIBs or any other concentrates containing Li, Co, Ni, or Mn. The examples discussed herein below are focused primarily on the recovery of these materials from the cathode materials derived from waste LIBs.

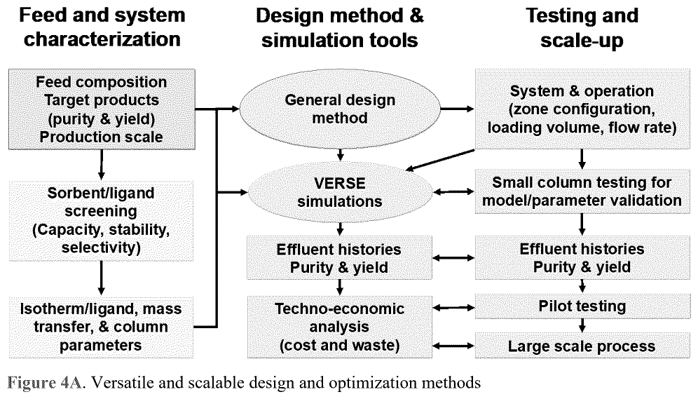

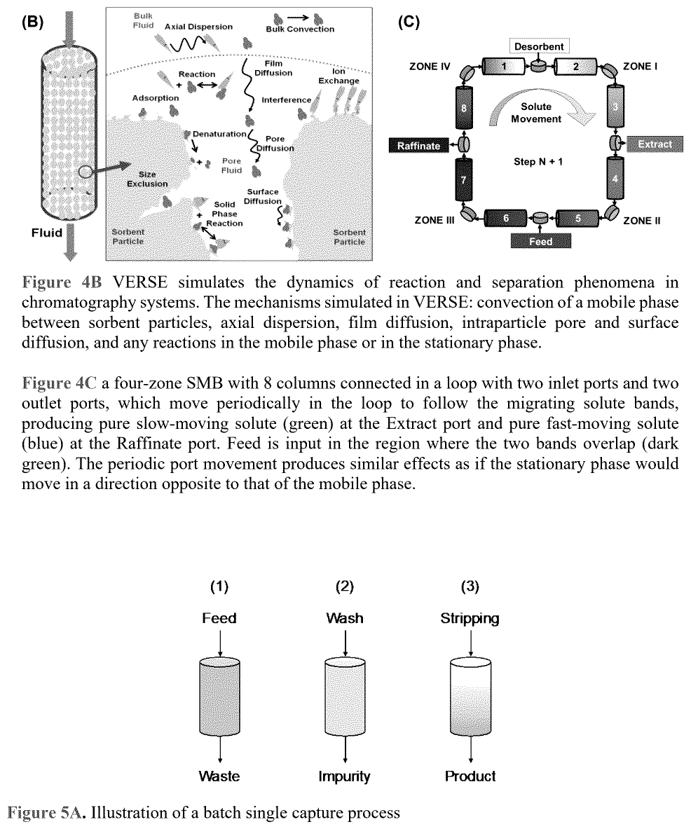

The instant novel technology employs versatile multi-dimension, multi-mode chromatography methods for the separation and purification of critical materials from the cathode materials of waste LIBs and other complex mixtures. Three “dimensions” or axes are considered and evaluated in the design of the separation of the target solutes from impurities. (1) X-axis: the interactions of the solutes with the functional groups on the stationary phase, such as sulfonic acid, iminodiacetic acid, aminophosphonic acid, phosphoric acid, or trimethylammonium groups; (2) Y-axis: the separation modes, including capture, elution, or displacement modes. For each mode, there are considered two types of operations: batch separation and continuous separation; (3) Z-axis: the interactions or reactions of solutes with agents in the mobile phase, such as soluble organic solvents, ions (hydrogen ions, hydroxyl ions), or chelation agents (see FIG. 4).

Different separation strategies are designed based on the consideration of the three dimensions as shown in FIG. 4. A specific separation strategy will have a unique coordinate in the three-dimensional space. In the first dimension (X-axis), the selectivity of various stationary phases (or sorbents) for the desired product species should be evaluated first. Ideal sorbents should have a high selectivity (>10) for either the product or the impurities. If the sorbent selectivity for the product species over the impurities is high (>10) and the sorbent has a high capacity, the sorbent can be used in a capture process to capture the product species. Capture processes (the first separation mode in the Y-axis) are relatively easy to design, can have a high productivity and high yield, and potentially have the lowest processing costs. Alternatively, if the sorbent has a high selectivity for the impurities, the sorbent can be used in a capture process for removal of the impurities from the product species. Initial screening and evaluation of different sorbent candidates are performed so as to choose the sorbent with the highest selectivity and capacity for the capture targets. An example of capturing three impurities (iron, copper, and aluminum ions) from the leaching solution of the LIB cathode materials is discussed in Example 1 below.

Capture method can also be used for separating Mg from Li from Li-rich brine. An iminodiacetic acid resin-packed column can capture Mg ions while Li elutes earlier as a high purity product as discussed in Example 2 below.

If multiple products are desired and each one of the products has an ideal sorbent for capture, tandem capture method is typically used. For the recovery of multiple components (Li, Co, Ni, Mn) from a feedstock (leachate of cathode materials from LIBs), a tandem capture process for the sequential recovery of Mn, Co, Ni, and Li is discussed in Example 3.

An example of the recovery of Ni from a mixture of Li and Ni in a continuous carousel capture process is discussed in Example 4.

High purity Li chloride (LiCl) or Li sulfate (Li₂SO₄) salts produced from the tandem capture processes can be converted into high purity lithium hydroxide (LiOH) in an anion exchange process. The column pre-equilibrated with hydroxyl ions (OH) can be used as a capture column for chloride or sulfate ions. The chloride or sulfate ions in the feed solution exchange with the hydroxyl ions in the resin, resulting in the elution of LiOH from the column. The LiOH in the solution can be crystallized to produce LiOH solid. This process is discussed in detail in Example 3 below. In conventional production, lithium chloride or lithium sulfate is first precipitated with sodium carbonate (Na₂CO₃) to form Li₂CO₃, which is then reacted with calcium hydroxide (Ca(OH)₂) to form LiOH. The final product usually contains a small amount of Li₂CO₃ or CaCO₃. The LiOH produced from the anion exchange process is free of any carbonates. This process is discussed in Example 5 below.

If the desired components have similar structures and properties, fractionation methods (the second and third separation modes in the Y axis), such as elution or displacement methods, can be designed to recover the individual components. An example of displacement separation for the recovery of Li, Co, Ni, and Mn from the leaching solution of LIB cathode materials is discussed in Example 6.

A pilot scale testing of Li purification is discussed in Example 7 below. This example demonstrated the scalability of the purification method as it was a direct 10 times or more scale-up from lab scale testing.

A 4-zone simulated moving bed for the separation of Ni from Li from a binary mixture is discussed in Example 8.

A 6-zone simulated moving bed for the continuous splitting of Li from Ni, Co, and Mn is discussed in Example 9 below.

If none of the potential sorbents (X-axis) have sufficient selectivity for economical capture or fractionation (Y-axis) of the product species, the third dimension (Z-axis) is then considered. Selective chelating or other agents can be added in the mobile phase, elution or displacement methods, and are designed to achieve separation and recovery.

The choice of the separation modes (Y axis) depends on the number and properties of the desired products. If a single product is desired and an ideal sorbent is available, one can use capture chromatography to capture the desired product or to capture all the impurities. If multiple products are desired and each one of the products has an ideal sorbent for capture, tandem capture method is typically used. If only one or several, but not all products, have ideal sorbents, capture or tandem capture in combination with fractionation methods are considered and may be designed to recover all desired products. If none of the desired products has an ideal sorbent for capture, fractionation processes are considered and may be tailored based on sorbent separation factors or interactions or reactions in the mobile phase (Z-axis).

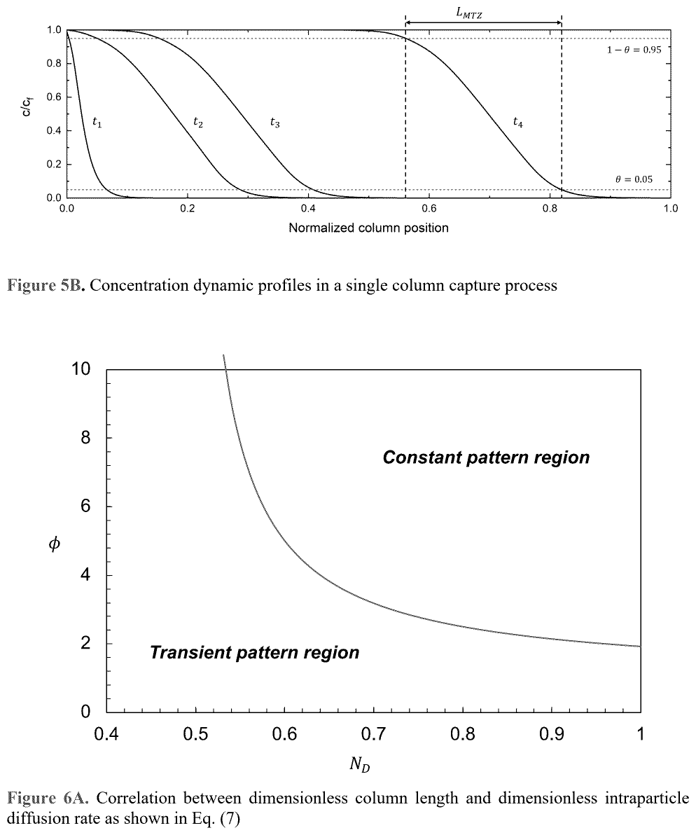

The general design methods disclosed herein are applicable to a wide range of feed compositions, process scales, and product requirements (see FIG. 5A-5C). The system dimensions and operating conditions can be adapted to any scale for any feed compositions. The methods are robust and can account for variations in compositions or operation conditions.

A general rate model and simulation package has been developed based on detailed rate models for multi-component adsorption and chromatography with reactions in the mobile or the stationary phase. The model can simulate reactions and separations in single columns, carousels, simulated moving beds, and other continuous chromatography processes.

The model is a general simulator that can generate “Digital Process Twins,” or accurate models of the actual processes, for a wide range of liquid chromatography systems with reactions. The so-generated simulations are based on first principles and intrinsic (scale-independent) parameters. The fundamental mechanisms of convection, axial dispersion, film mass transfer, intra-particle diffusion, pore diffusion, surface diffusion are considered in mass balances with general rate equations. Solute adsorption/desorption phenomena are considered in various equilibrium adsorption equations or non-equilibrium adsorption rate equations. Various reactions in the mobile phase or in the stationary phase are considered in specific reaction kinetics equations. The intrinsic parameters for these processes can be estimated, such as by using a few lab-scale experiments. Based on the parameters, the rate models, and the specific operations, the model generates dynamic column profiles and effluent histories to elucidate complex multi-component adsorption, reaction, and separation phenomena in batch or continuous processes.

The model is a valuable tool for teaching, researching, or developing new theories or new processes. After some verification of the rate models and the intrinsic parameters with a few lab-scale tests, the model simulations can minimize the number of actual experiments required and reduce the time and costs for developing new theories or new processes. Dynamic column profiles and effluent histories can be simulated in a few minutes using a personal computer, whereas actual experiments may take days or weeks. After successful testing of the models and parameters at a lab-scale, the model may be used to scale-up the lab-scale process to pilot-scale for further testing before scaling up the process for commercial production. The model can also be integrated with models of pre-chromatography or post-chromatography operations in a plant-wide model for optimization of the entire production process to develop the most economical and environmentally friendly process.

The above capture and purification method was also generalized for designing affinity chromatography (with high-selective ligands in the stationary phase), which is widely used for the recovery of antibodies, enzymes, or other biochemicals. This generalized design method, which was based on analytical solutions and intrinsic parameters, was predictive and did not need process simulations or many experiments. Once the intrinsic adsorption and diffusion parameters were estimated from a few bench-scale experiments, it was straightforward to design an efficient capture chromatography process to meet yield and throughput requirements.

The model was useful in development of chromatography theories and methods for systems with a selective functional group (chelating agent) either in the mobile phase and/or immobilized on the stationary phase. Model simulations are used in this application for supporting the validity of the new methods. Close agreement of model simulated chromatograms with experimental chromatograms resulting from the new design methods further supports the validity of the new design methods.

The following methods are explained in detail below, using examples for the recovery and purification of critical materials from waste LIBs or Li-rich brines: (1) single column (batch) capture method; (2) tandem capture methods; (3) anion exchange method; (4) continuous carousel capture; (5) displacement fractionation methods; and (6) continuous multi-zone simulated moving bed fractionation.

### Constant-Pattern Single-Column (Batch) Capture Method

Single-column capture methods are simpler to design and to implement, and they have higher throughputs than fractionation methods, such as elution or displacement. For these reasons, capture methods are typically tested and evaluated first, before considering elution or displacement methods.

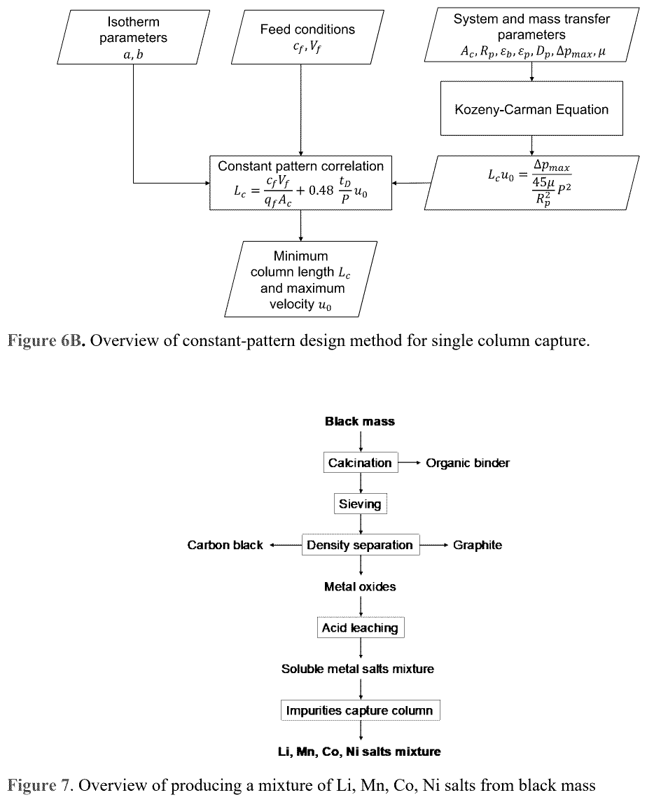

Various sorbents are typically screened for high selectivity (>10) for the desired products and/or the impurities. If such an affinity sorbent is available, a single-column capture process may be designed, tested, and evaluated. A single-column capture process consists of three steps: (1) capture of target component(s) from a complex mixture, (2) washing for removal of non-adsorbing components, and (3) stripping of the target component(s) (see FIG. 6A).

The concentration profiles in a single column capture process are shown in FIG. 6B. The concentration waves are spread due to diffusion and dispersion effects. The length of the region where concentration changes from 95% to 5% of the feed concentration is defined as mass transfer zone length at a cut of 0.05 (θ=0.05) (FIG. 5B). Mass transfer zone length increases as the concentration wave migrates in the column (t₁-t₃). If the column is sufficiently long, the wave spreading is counterbalanced by wave sharpening due to adsorption, the shape of the concentration wave and the mass transfer zone length will remain fixed (t₄). This wave is called a constant pattern wave.

Advantages of constant-pattern capture. Constant-pattern design methods for batch capture and continuous capture are described herein. For a single-column capture (or batch capture), operating at constant pattern can achieve the highest column capacity utilization. This is beneficial when capturing valuable products using an expensive sorbent. The constant-pattern design method can also guarantee a required capture yield for the target products. This design is also relatively simple, flexible, and robust with respect to variations in feed concentrations, linear velocities, and column capacities.

Minimum column length for the formation of constant pattern. If a constant pattern wave forms before the wave exits the column, the wave will travel the remainder of the column with no change in its shape. The length of mass transfer zone remains the same. The yield will not be improved with extra column length, but the sorbent productivity (based on per column volume) will decrease as a result of a long capture time. In order to maximize the productivity it is advantageous to find the minimum column length to reach the constant pattern for the capture process. A general correlation is described below for predicting the minimum column length for reaching a constant pattern in a single column capture process.

For a given feed composition c_{f} and feed volume V_{f}, the minimum column length to capture all the desired solute in an ideal system (no wave spreading due to diffusion or dispersion effects) is depended on the equilibrium column capacity at the given feed concentration c_{f}. When the column is equilibrated with c_{f}, the equilibrium column capacity q_{f} for a given feed concentration c_{f} can be described using the Langmuir isotherm:

$${q}_{f} = \frac{a {C}_{f}}{1 + b {C}_{f}} \qquad ( 1 a )$$

In highly non-linear systems, where bC_{f}>>1, Eq. (1a) can be simplified to

$${q}_{f} = \frac{a {C}_{f}}{b {C}_{f}} = \frac{a}{b} = {q}_{max} \qquad ( 1 b )$$

where a and b are the Langmuir isotherm constants. The minimum column length should satisfy the following equation when the amount of solute filling the pores of the stationary phase is negligible:

$${C}_{f} {V}_{f} = {L}_{c , i d} {A}_{c} {q}_{f} \qquad ( 2 a )$$

L_{c,id} can be calculated as

$${L}_{c , i d} = \frac{{C}_{f} {V}_{f}}{{q}_{f} {A}_{c}} \qquad ( 2 b )$$

A general dimensionless column length ϕ can be expressed as the ratio of L_{c} and L_{c,id}:

$$ϕ = \frac{{L}_{c}}{{L}_{c , i d}} = \frac{{L}_{c}}{\frac{{C}_{f} {V}_{f}}{{q}_{f} {A}_{c}}} = \frac{{q}_{f} {V}_{c}}{{C}_{f} {V}_{f}} = \frac{1}{{L}_{f}} \qquad ( 3 a )$$

Where L_{f} is the loading fraction, which is defined as the fraction of the equilibrium capacity used for capture.

$${L}_{f} = \frac{{C}_{f} {V}_{f}}{{q}_{f} {V}_{c}} \qquad ( 3 b )$$

The constant-pattern wave in capture chromatography can be considered as a special case of the constant-pattern wave in displacement chromatography, where the selectivity a between the adsorbed solute and the presaturant species is infinity. As derived previously for displacement chromatography, the minimum column length to reach constant pattern is correlated to loading fraction and mass transfer coefficient:

$${ϕ}_{min} = \frac{{L}_{c , min}}{{L}_{c , id}} = \frac{{L}_{f , id}}{{L}_{f}} = 1 + \frac{7.2}{X} where X = {L}_{f} {k}_{f}^{*} \frac{( {α}_{e} + 1 )}{( {α}_{e} - 1 )} . \qquad ( 4 )$$

For the wave in capture chromatography, de is infinity, and therefore, X=L_{f}k*_{f}, where
k*_{f} is the overall dimensionless mass transfer coefficient, which can be estimated as follows:

$$\frac{1}{{k}_{f}^{*}} = \frac{1}{P {e}_{b}} + \frac{1}{{N}_{f}} + \frac{1}{15 {N}_{D}} \qquad ( 5 a )$$

where Pe_{b} is Peclet number, N_{f} is the dimensionless film mass transfer rate, and N_{D} is the dimensionless intraparticle diffusion rate relative to convection rate:

$${N}_{D} = P \frac{1}{{t}_{D}} \frac{{L}_{c}}{{u}_{0}} where P = \frac{1 - {ε}_{b}}{{ε}_{b}} \qquad ( 5 b )$$

is the phase ratio,

$${t}_{D} = \frac{{R}_{p}^{2}}{{ε}_{p} {D}_{p}}$$

is a characteristic diffusion time, and u₀ is the linear interstitial velocity.

In a diffusion-controlled system, Eq. (5a) can be simplified to

$$\frac{1}{{k}_{f}^{*}} = \frac{1}{15 {N}_{D}} = \frac{{u}_{0} {t}_{D}}{15 P {L}_{c}} \qquad ( 5 c )$$

In a capture system, where Eq. (3a) applies, Eq. (4) can be simplified to

$${ϕ}_{min} = \frac{1}{{L}_{f}} = 1 + \frac{7.2}{{L}_{f} {k}_{f}^{*}} \qquad ( 6 a )$$

$$Or$$

$${L}_{f} = 1 - \frac{7.2}{{k}_{f}^{*}} \qquad ( 6 b )$$

In a diffusion-controlled capture system, k*_{f} in Eq. (6b) can be substituted by Eq. (5c), which yields

$${L}_{f} = 1 - \frac{7.2}{15 {N}_{D}} = 1 - \frac{0.48}{{N}_{D}} = 1 - 0.48 ( \frac{{t}_{D}}{P} \frac{{u}_{0}}{{L}_{c}} ) \qquad ( 6 d )$$

$$or$$

$$ϕ = \frac{1}{{L}_{f}} = \frac{{N}_{D}}{{N}_{D} - 0.48} \qquad ( 6 e )$$

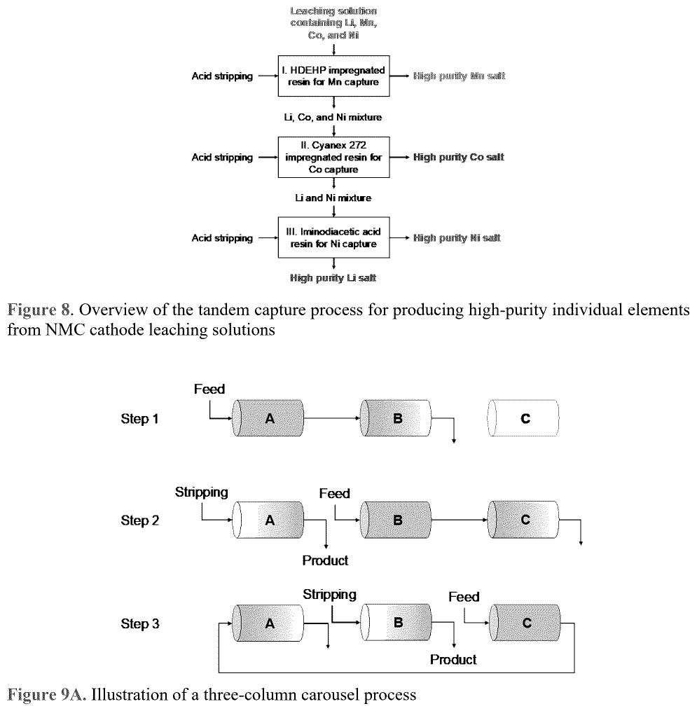

For diffusion-controlled systems, ϕₘᵢₙ is a function of N_{D}, which divides the design space into the transient region and the constant pattern region for single column capture. A plot of ϕₘᵢₙ vs. N_{D}, is shown in FIG. 7A. For N_{D}=1, ϕₘᵢₙ is about 1.9, which means the minimum column length to reach constant pattern for capture is about 1.9 times the column length for a corresponding ideal system, L_{c,id}.

The derivation of the general correlation is based on displacement chromatography with the following assumption: (1) the adsorption isotherm is highly nonlinear; (2) the amount of solute remaining in the intraparticle void is negligible compared to adsorbed amount; (3) the system is diffusion controlled; and (4) the value of feed concentration (c_{f}) is much lower than the column volume basis capacity (q_{f}). Same assumptions should be met when applying the general correlation to capture chromatography. The minimum column length estimated from this general correlation is conservative as the correlation was based on the cut for the mass transfer zone length of 0.0001.

Combining Eq. (3b) and Eq. (6d) will give

$${L}_{c , id} = \frac{{c}_{f} {V}_{f}}{{q}_{f} {L}_{c} {A}_{c}} = 1 - \frac{0.48}{{N}_{D}} = 1 - 0.48 \frac{{t}_{D}}{P} \frac{{u}_{0}}{{L}_{c , min}} \qquad ( 7 )$$

Rearranging Eq. (7) can yield the minimum column length for a given feed volume to reach constant pattern capture frontal wave:

$${L}_{c , min} = \frac{{c}_{f} {V}_{f}}{{q}_{f} {A}_{c}} + 0.48 \frac{{t}_{D}}{P} {u}_{0} \qquad ( 8 )$$

The productivity PR of the capture chromatography can be defined as

$$P R = \frac{{c}_{f} {V}_{f}}{{t}_{L} {L}_{c} {A}_{c}} \qquad ( 9 a )$$

The column length, Eq. (8), can be combined with Eq. (9a) to give

$$PR = \frac{{c}_{f} {V}_{f}}{{t}_{L} {L}_{c} {A}_{c}} = \frac{{c}_{f} {V}_{f}}{{t}_{L} {A}_{c} ( \frac{{c}_{f} {V}_{f}}{{q}_{f} {A}_{c}} + 0.48 \frac{{t}_{D}}{P} {u}_{0} )} \qquad ( 9 b )$$

$$where {t}_{L} = \frac{{V}_{f}}{{u}_{0} {ε}_{b} {A}_{c}}$$

is the loading time for a given feed volume. Substituting t_{L} in Eq. (9b) yields:

$$P R = \frac{{c}_{f} {ε}_{b}}{( \frac{{c}_{f} {V}_{f}}{{q}_{f} {A}_{c} {u}_{0}} + 0.48 \frac{{t}_{D}}{P} )} \qquad ( 9 c )$$

Eq. (9c) reveals that the productivity is a function of linear velocity for a given feed volume. The higher the linear velocity, the higher the productivity. However, the linear velocity will be constrained by the maximum pressure drop of the system. The pressure drop across the column can be calculated using Kozeny-Carman Equation, as shown in the equation below.

$$\frac{Δ {p}_{max}}{{L}_{c}} = \frac{45 μ}{{R}_{p}^{2}} {P}^{2} {u}_{0} \qquad ( 10 )$$

Combining Eqs. (8) and (10), one can calculate the minimum column length as well as the maximum allowed linear velocity to achieve constant pattern frontal wave and optimal productivity. If column length is fixed in existing equipment, one can calculate u₀ from Eq. (8) and apply Eq. (10) to check whether the pressure drop is below Δpₘₐₓ. The maximum loading fraction for the wave to reach constant pattern for the given column length can be calculated from Eq. (6e).

The overview of design method is shown in FIG. 7B.

The capture targets can be either desired product component(s) or undesired impurities. If the sorbent has a high selectivity (separation factor>10) for a single desired product component, the capture process is designed to capture the desired product with a high yield (>99%), while weakly adsorbing or non-adsorbing impurities are displaced by the strongly adsorbed component and collected in the column effluent during the loading and washing steps.

To achieve a high yield (>99%) of the captured component, one can use a breakthrough cut of 0.05 or smaller. The adsorbed component is then stripped as a high-purity product. If the sorbent has a high affinity for multiple desired product components in the feedstock, the capture process is tailored to capture all the desired components with high yields. After washing to remove the impurities, the desired product components can be stripped as a mixture or a concentrate of desired products, which can be further separated or purified with other methods.

If the sorbent has a high affinity to all the impurities, the capture process is tailored to capture all the impurities. Weakly adsorbing or non-adsorbing product components are collected during loading and washing steps. The collected mixture of desired products can be further separated or purified by using fractionation methods. The capture column is then regenerated by stripping the adsorbed impurities.

If both the sorbents for product-capturing and impurity-capturing are available at a similar cost and the stripping chemical costs are also similar, the sorbent with a high capture capacity for the minority components is typically chosen for the capture process to reduce the required column volume and the amount of required stripping chemicals.

### Tandem Constant-Pattern Capture Method

Capture of impurities Black mass is derived from waste lithium-ion batteries. It can be used as a feedstock to produce high-purity salts of Li, Mn, Co, and Ni for making the metal oxides such as for NMC cathode materials. Black mass includes carbon black, graphite, and metal oxides, and also has minor or trace amounts of various impurities. A calcination step is used first to remove the organic binder in black mass, followed by a sieving step for removing large particles (for example, particles having dimensions greater than 106 microns), mostly iron, copper, and aluminum. Carbon black and graphite can then be separated from the cathode materials (metal oxides) using floatation or density separation methods based on the differences in density and/or particle size. However, the metal ion impurities, Fe³⁺, Cu²⁺, and Al³⁺, are likely to be present with the metal oxides derived from black mass. Some chelation resins, such as iminodiacetic acid and aminophosphonic acid resins, and the like have a high affinity for such impurities. A capture process has been designed to capture the impurities. Leaching solution containing desired critical materials (Li⁺, Mn²⁺, Co²⁺, and Ni²⁺) and the impurities (Fe³⁺, Cu²⁺, and Al³⁺) is fed into the capture column, in which the impurities are adsorbed while the desired ions elute ahead of the impurities. A mixture containing only Li, Mn, Co, and Ni salts is produced and can be used for making the NMC cathode or as a feedstock for further purification to produce high-purity individual elements. The overview of this process is shown in FIG. 8.

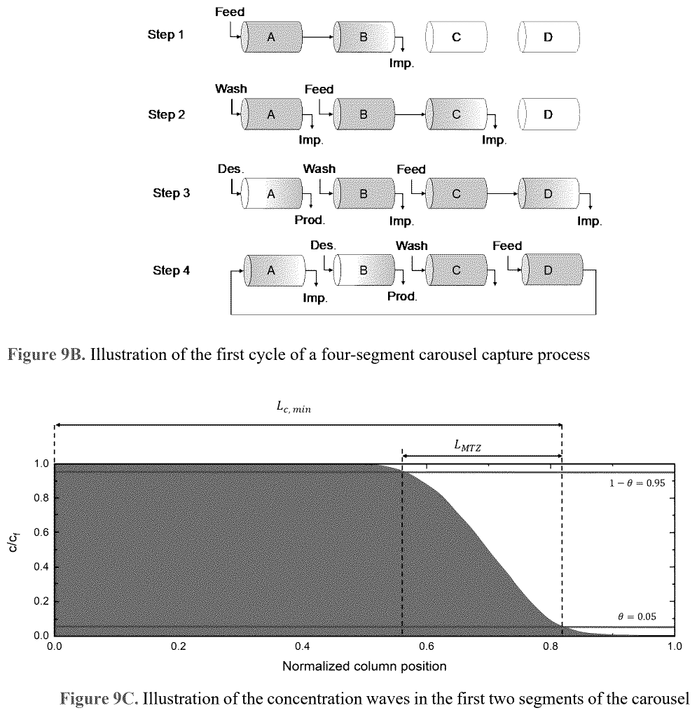

Tandem capture of Mn²⁺, Co²⁺, and Ni²⁺ If selective sorbents are available for capturing each individual component from a complex mixture, capture methods can be applied in tandem to produce high purity Li, Co, Ni, and Mn salts as an alternative to single-column fractionation methods. After impurities capture, the leaching solution contains only Li, Mn, Co, and Ni ions. High impurity Mn, Co, Ni, and Li salts can be produced through a three-step tandem capture process (see FIG. 9A).

At pH 2.5, Mn²⁺ in the leachate was selectively captured by HDEHP impregnated resin, while other components in the leachate are non-adsorbing. Captured Mn was stripped by using a dilute acid and precipitated by adjusting the solution pH to 9 to produce high-purity Mn hydroxide or crystalized as high purity Mn sulfate.

The pH of the Mn-free effluent, containing Li, Co, and Ni, from the Mn capture column was adjusted to pH 4.5 and then loaded into a Cyanex 272 impregnated resin column, where Co was selectively captured at pH 4.5, while Li and Ni were non-adsorbing. High-purity Co salt solution fraction was produced from this column after stripping by a dilute acid and precipitated as hydroxide by adding a base to adjust the solution pH to 6. The Co fraction can also be crystalized to form Co salt crystals. The early effluent from this column contained only Li and Ni.

A chelation resin with iminodiacetic acid functional groups has a much higher affinity to Ni than Li (separation factor>10), and it was used for capturing Ni from the binary Li and Ni mixture. Early eluting Li was collected in the effluent as a high-purity fraction, which was precipitated as a carbonate salt. The Ni captured in the column was stripped off by using an acid. The Ni in the acid solution could be precipitated as a high-purity Ni hydroxide (by using a base) or crystalized as a high purity Ni salt.

### Anion Exchange

Li products produced from purification steps are typically either chloride salt or sulfate salt. However, the synthesis of cathode active materials for lithium ion batteries would require either Li₂CO₃ or LiOH.

Conventional method for producing high purity Li₂CO₃ requires addition of a precipitant, such as Na₂CO₃ at elevated temperature and washing precipitated Li₂CO₃ with hot water. The product from single step precipitation usually cannot meet the purity requirement for cathode active material synthesis. Thus, in the known art, multiple steps of re-dissolution and re-precipitation are required to upgrade the purity.

Conventional method of producing high purity LiOH from these salts comprises the following steps: (1) precipitation of Li using Na₂CO₃; (2) filtration and drying of Li₂CO₃ solid; (3) reaction between Li₂CO₃ and lime to form LiOH and CaCO₃; (4) leaching of LiOH; (5) evaporation and crystallization of LiOH. This conventional method is tedious and has associated high risk of Ca or carbonate contamination in the final products.

Alternatively, in the instant novel technology an anion exchange capture process has been generated based on constant pattern capture techniques disclosed herein. Type I anion exchange resins have a higher affinity to sulfate and chloride than hydroxide. High purity LiCl or Li₂SO₄ solution collected from the tandem capture process can be used as the feedstock. When Li salt solution is loaded into a column saturated with hydroxide ions, chloride and/or sulfate ions could displace hydroxide ions and be captured in the column. The effluent is high purity (>99.9%) LiOH. If Li₂CO₃ is required as a product, carbon dioxide gas can be used to convert high purity LiOH to Li₂CO₃ without introducing other impurities. The new method has fewer steps compared to conventional methods and has substantially no contamination.

### Constant-Pattern Carousel Capture

Single-column capture method usually has limited column capacity utilization as the flow rate for the capture increases. Wave spreading due to mass transfer resistance increases with increasing flow rate. To keep a high capture yield at 99% or higher, breakthrough cut is usually kept at 0.05 or lower. As a result, a large fraction of the column is needed to contain the spread concentration wave, leading to a low sorbent capacity utilization.

If an adsorbent is substantially perfectly selective for the target solute, one can achieve high product yield, high throughput, and high column utilization by designing a carousel capture process. A carousel process for capture usually has three or more segments. If the feed does not have any non-adsorbing impurities, a three-segment carousel can work to recover the target solute as shown in FIG. 9A. In Step 1, segments A and B are connected; the first segment A is used as the “saturation” column, segment B is used to confine the concentration wave, and the third segment is a backup segment. At the end of Step 1, segment A is fully saturated. In Step 2, the feed port is switched from the inlet of A to the inlet of B and the outlet of B is connected to the inlet of C to continue the capture process, while segment A is stripped to recover the target solute. In Step 3, both feed and the stripping port move to the next segment. Segments C and A are now connected and carry on the capture process, while segment B is stripped and regenerated.

If the feed contains non-adsorbing impurities, a washing step can be added before the stripping step to remove the nonadsorbing impurities from the bed void or the particle pores. This washing step can prevent any non-adsorbing impurities from contaminating the product. Alternatively, a four-segment carousel process with a washing zone prior to stripping can be implemented as shown in FIG. 9B. In Step 1, segments A and B are connected; the first segment A is used as the “saturation” column, segment B is used to confine the concentration wave, and the third segment is a backup segment. Non-adsorbing or weakly adsorbing impurities are collected in the effluent of B as waste. At the end of Step 1, segment A is fully saturated. In Step 2, the feed port is switched from the inlet of A to the inlet of B and the outlet of B is connected to the inlet of C to continue the capture process. During the loading of B and C in Step 2, a wash solvent is used to remove the non-adsorbing impurities in the bed void or pores of the sorbent in segment A, and the effluent from segment A is collected as waste.

In Step 3, both feed and wash port move to the next segment. Segments C and D are now connected and carry on the capture process while segment B is washed. Segment A is stripped and regenerated. The captured product is collected in the effluent of Segment A. In the last step of the first cycle, all ports move to the next segment. Segment D is connected to Segment A, which has been cleaned in Step 3, and continue capturing product from the feed, while Segment C is washed, and Segment B is stripped and regenerated. After three cycles, the carousel process usually reaches a cyclic steady state.

In this novel technology, the length of the column segment is designed to reach a constant-pattern state for capture of a single component. The adsorption isotherms in most high affinity systems follow the Langmuir (convex) isotherms. When the column is sufficiently long, a constant pattern mass transfer wave will eventually develop in the column for Langmuir systems. The column capacity in the mass transfer zone is not fully utilized. The length of the segments and the flow rate in the carousel process is designed so that the concentration wave reaches the constant pattern as described in single column capture process.

One simple design method is to have the first segment to be fully saturated with product and the second segment to contain exactly the constant pattern mass transfer zone, FIG. 9C. In the design, the combined length of two segments is the minimum column length in the constant-pattern design method for single-column capture. Assuming the wave spreading in the second segment is symmetric, the loading fraction should be 0.75. Total column length can be calculated from Eq. (3a) by setting the loading fraction to be 0.75.

$${L}_{c} = \frac{4}{3} {L}_{c , i d} = \frac{4}{3} \frac{{c}_{f} {V}_{f}}{{q}_{f} {A}_{c}} \qquad ( 11 )$$

Each carousel segment will have a length of

$$\frac{{L}_{c}}{2}$$

in a three-segment carousel.

The linear velocity required to reach constant pattern can be calculated from Eq. (8) with given column length L_{c}.

This constant pattern design can guarantee the highest productivity for the desired yield of the captured product. Carousel process can be implemented for the capture of impurities from black mass as well as for each capture process in the tandem capture processes to produce high-purity individual elements.

### Displacement Fractionation

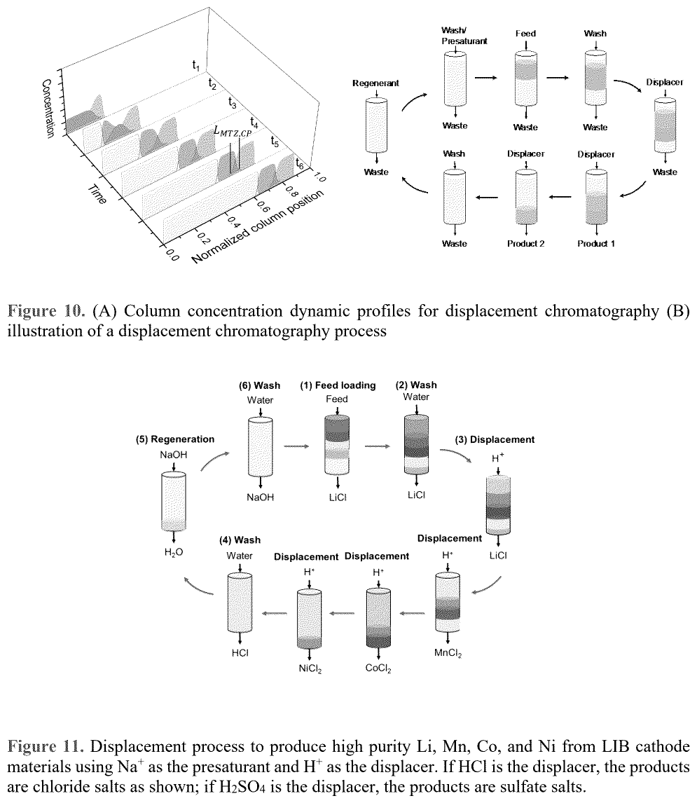

Displacement fractionation uses only one type of sorbent and a minimum amount of solvent and chemicals, which can potentially minimize the separation costs. Displacement chromatography uses a displacer, which has the highest sorbent affinity, to displace, separate, and concentrate adsorbed solutes (see FIG. 10).

During loading, the high-affinity solute displaces the low-affinity solute, resulting in a roll-up of the low-affinity solute band. Partial separation occurs during the loading (t₁). A strongly adsorbing displacer is introduced into the column after the loading (t₂). The displacer has the highest affinity for the stationary phase; hence it displaces the high-affinity solute component, which in turn displaces the low-affinity solute component. The mixed region between the low and high affinity solute bands narrows as the displacer displaces the two solutes in the column (t₃) and is eventually eliminated (t₄). This is called the “self-sharpening effect” in displacement systems. The low and high affinity solutes form trapezoidal bands with sharp boundaries. These two bands move in the column at the same speed as the displacer front (t4−t6). This is called the formation of an “isotachic train” in displacement chromatography.

Specifically, for the separation of metal ions in the LIB cathode leaching solution, resins with iminodiacetic acid functional groups can be used, as those have the highest affinity to Ni²⁺, followed by Co²⁺, then Mn²⁺, and Lit. The selectivity between adjacent elements is quite high (typically greater than 4).

A convenient presaturant is a species that exhibits a lower selectivity than those for the divalent metals of interest. For instance, one can start with an IDA column presaturated with Na⁺ or NH₄⁺ (see FIG. 11). During feed loading, partial separation occurs as Ni displaces Co, which in turn displaces Mn. Weakly adsorbing Li elutes early. A wash step follows the feed loading to further remove weakly adsorbing Li and to ensure adsorption of the feed components in the void. A dilute acid (0.5 M) can be used as a displacer since the IDA resin has the highest affinity to H⁺. Displacement bands will develop in the column and high purity salts will be produced. After the displacement, the column will be saturated with H⁺ and will be regenerated by NaOH (or NH₄OH) wash followed by water wash.

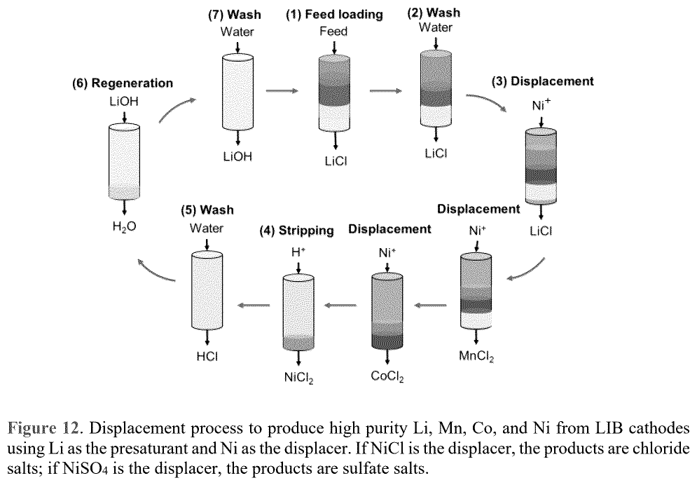

Alternatively, instead of using species like Na⁺ or NH₄⁺ as the presaturant and H⁺ as the displacer in conventional displacement, one can also use the component with the lowest affinity in the complex mixture to be separated, Li, as the presaturant and the component with the highest affinity, Ni, as the displacer (see FIG. 12). In this case, the column is pre-equilibrated with Li. When the feed mixture is loaded into the column, Li will elute early while partial separation occurs in the loading zone. Similar to conventional displacement, a wash step may also be needed to wash out the non-adsorbing solute and to ensure the adsorption of solute in the void in the loading zone. Ni salt solution is used as the displacer to develop the isotachic train in the column. After displacement, the column is saturated with Ni ions, which can be quickly stripped off using a dilute acid. The column can then be washed and regenerated with LiOH and water.

A higher displacer concentration can be used when using Ni²⁺ instead of H⁺ as the displacer species since it is less corrosive to equipment and sorbent. This gives rise to higher displacement band concentration, higher product concentration, and higher sorbent productivity. The use of Li as presaturant eliminates additional Li purification steps by producing pure Li directly from the column. When species like Na⁺ or NH₄⁺ are used as presaturants, they coelute with Li as they exhibit a similar selectivity.

The operating conditions (feed volume V_{f} and linear velocity u₀) to achieve certain yield or purity requirement for a given feed mixture and a given column can be found using constant pattern design method for non-ideal displacement chromatography. A general correlation, Eq. (4), was developed to predict the minimum column length required for the formation of constant pattern isothachic train in non-ideal displacement systems.

The yield of a component (Yᵢ) in displacement systems is defined as:

$${Y}_{i} = 1 - \frac{β}{2 {L}_{f} {k}_{f}^{*} {γ}_{i}} \qquad ( 12 )$$

$$where β = ln \frac{1 - θ}{θ}$$

and θ is the breakthrough cut, L_{f} is the loading fraction, k*_{f} is the overall dimensionless mass transfer coefficient which is defined in Eq. (5a), and yᵢ is the selectivity weighted composition factor, which is defined as

$${γ}_{i} = \frac{{x}_{i}}{\frac{{α}_{i + 1 , i} + 1}{{α}_{i + 1 , i} - 1} + \frac{{α}_{i , i - 1} + 1}{{α}_{i , i - 1} - 1}} \qquad ( 13 )$$

where xᵢ is the molar fraction of component “i” and αᵢ₊₁, and α_{i,i-1} are the selectivites between component “i” and its adjacent components.

The purity of a component can be correlated to yield and breakthrough cut:

$${Purity}_{i} = 1 + ( \frac{1}{{Y}_{i}} - 1 ) \frac{ln ( 1 - θ )}{β} \qquad ( 14 )$$

In the design of displacement separation, the purity requirement and the breakthrough cut are usually specified first. When a minimum purity and θ are defined, there is a minimum yield required to reach that purity as indicated by Eq. (14). The target yield in the design cannot be lower than this minimum yield requirement. For a specific column, after determining the feed compositions and the isotherm parameters, the maximum loading fraction allowed for an ideal system, L_{f,id} for reaching an isotachic state can be calculated from the wave interference theory. If a specific yield is required, then a L_{f}k*_{f} value can be calculated from Eq. (12). A X value is calculated by multiplying L_{f}k*_{f} and

$$\frac{α - 1}{α + 1} .$$

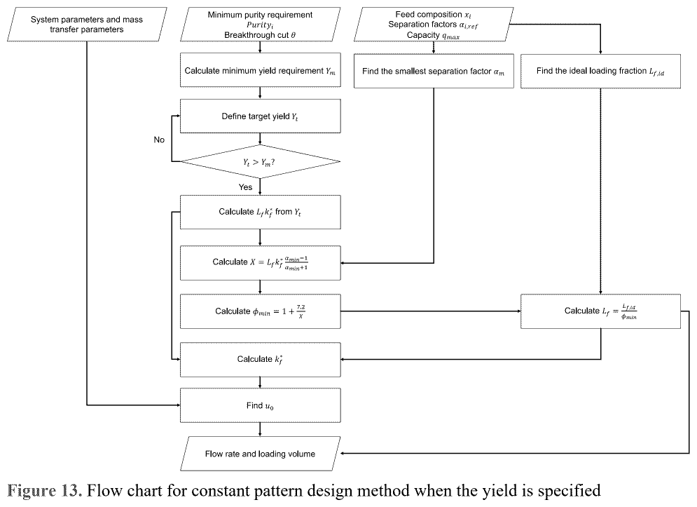

The separation factor should be the smallest separation factor among components in the mixture to ensure the formation of constant pattern. A ϕₘᵢₙ value is found from the general correlation. The loading fraction L_{f} is calculated from ϕₘᵢₙ and L_{f,id}. The value of k*_{f} is determined subsequently as the L_{f}k*_{f} value is known. The linear velocity, u₀, can be determined from the k*_{f} value. With given column dimensions, the loading volume and flow rate can be determined from L_{f} and u₀, respectively. A flow chart for this design algorithm is shown in FIG. 13.

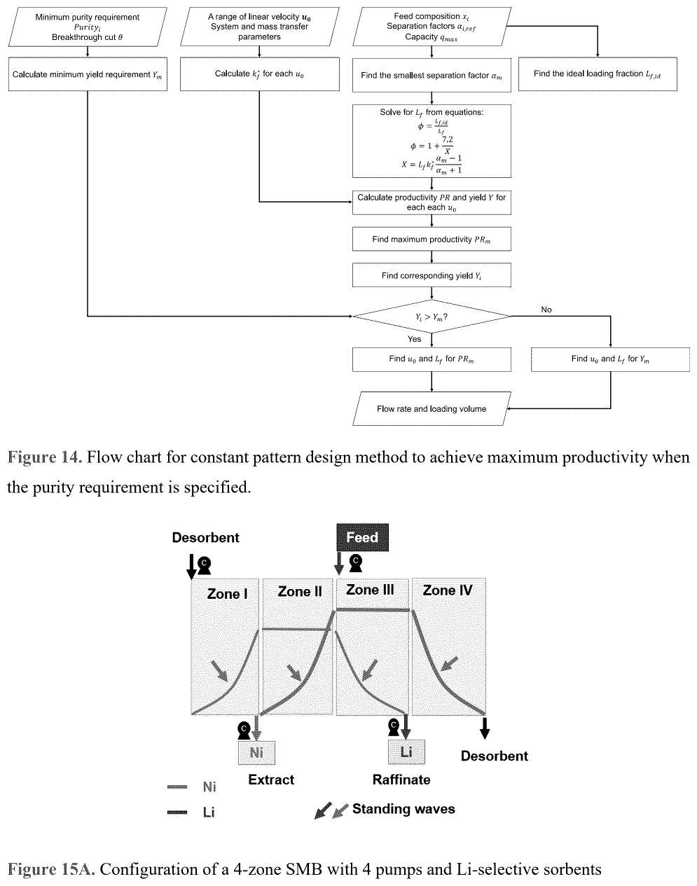

If the target yield is not specified, a range of linear velocities can be scanned to find the maximum productivity. For each linear velocity, the Peclet number, the dimensionless film mass transfer coefficient, and the dimensionless pore phase diffusion coefficient are calculated. A unique dimensionless overall mass transfer coefficient, k*_{f}, is determined for each linear velocity. In the constant pattern map, the x-axis is the product of loading fraction L_{f}, k*_{f}, and the selectivity term. The dimensionless column length, ϕ, is the ratio of L_{f,id} and L_{f}. There exists a unique L_{f} value that allows the ϕ value to locate on the constant pattern curve. Yields can be calculated using Eq. (12). The yield should be no less than the minimum yield requirement to reach the minimum purity with a fixed θ. An optimal productivity can be found with a specific loading fraction and a linear velocity. A flow chart for this design algorithm is shown in FIG. 14.

The constant pattern design method does not rely on experimental trial and error or simulations. Operating the system on the general constant pattern correlation guarantees the formation of a constant pattern isotachic train, in which the mass transfer zone length can be calculated using the shock layer theory and the intrinsic parameters. The mass transfer zone lengths and mass balance equations can be used for predicting the yields and the productivities. The operation parameters including the loading volume and flow rate are determined by solving the algebraic equations including yield equation (Eq. 12), purity correlation (Eq. 14), and mass transfer correlations. This design method enables easy and speedy optimization of displacement chromatography separations.

Several assumptions were made for developing the design method: (1) the amount of solute remaining in the intraparticle void is negligible compared to adsorbed amount, and (2) the value of non-linear distribution coefficient,

$${K}_{d} = P {ε}_{p} + \frac{{q}_{d}}{{ε}_{b} {c}_{d}} ,$$

is much greater than 1.

In the present novel technology, several modifications are made to accommodate the specific displacement separation configurations: (a) when the non-linear distribution coefficient is not much greater than 1 (see Examples 6 and 7); (b) when the presaturant or the displacer are components in the feed mixture (Example 6.2 and 6.3); (c) when a high linear velocity is applied to the feed loading and washing step to reduce the overall cycle time and to increase sorbent productivity (Example 7). A detailed explanation about the novel features are given below.

For the configuration (a), when the capacity of the sorbent q_{d} is in the same order of magnitude as the displacer concentration c_{d}, the non-linear distribution coefficient is not much greater than 1. A term

$${( \frac{{K}_{d}}{1 + {K}_{d}} )}^{2}$$

was multiplied to k*_{f} in the design to correct the length of the mass transfer zone length.

For the configuration (b), when Li is the presaturant, the Li in the feed acts as a non-adsorbing component. As a result, the design method does not consider Li as a feed component. When Ni is used as the displacer, the constant-pattern design method is applied for the binary separation of Mn and Co. However, besides the required column length for the separation of Mn and Co, the loading length that Ni in the feed mixture occupies needs to be considered as well. The column length subtracting the feed length of Ni should be sufficient for the separation of Mn and Co in the feed mixture.

For the configuration (c), one can increase the linear velocity during the loading to reduce the cycle time. The original design method for the displacement fractionation considers the partial separation of the components during the loading as the sorbent has different selectivities for different solutes. When a high linear velocity is applied in the loading and washing step, mass transfer resistance will significantly undermine the partial separation. As a result, an almost uniform mixed band will form near the entrance of the column. The displacement train will start forming when the displacer is introduced into the column. One can use the design method developed previously for the ligand-assisted displacement chromatography, instead of the design method for displacement chromatography.

### Continuous Fractionation in Multi-Zone, Multi-Mode SMB

Simulated Moving Bed (SMB) is a specific type of continuous chromatography. A typical SMB has eight columns, which are connected in a loop with two inlet ports (for adding desorbent and feed) and two outlet ports (for drawing extract and raffinate products), FIG. 4C. The ports move periodically along the mobile phase flow direction to follow the migrating solute bands in the loop. The port movement simulates countercurrent bed movement in the loop. The high-purity slow moving solute is drawn from the extract port, while the high-purity fast-moving solute is drawn from the raffinate port. The feed is introduced in the band-overlapping region. Unlike in batch chromatography, pure products are produced with high yields in SMB without the need for complete separation of the two solute bands in the loop. Products are not diluted, and a much larger fraction of the stationary phase is utilized in SMB. For these reasons, SMB can produce concentrated pure products with 99% yields and about 10 times higher sorbent productivity and solvent efficiency than batch chromatography.

One conventional design method, called the “triangle method” was based on the “ideal system” assumption, in which diffusion or any dispersion effects are negligible. This assumption is valid only for systems with micron-sized sorbent particles, which are costly and require the use of high-pressure equipment (>1,000 psi). The triangle method cannot guarantee product purities or yields for economical low-pressure SMB systems with large sorbent particles. Extensive searches using simulations or experiments in the 9-design parameter space are needed.

A standing concentration wave design method is developed based on the concept of confining a specific concentration wave in a specific flow-rate zone in multi-zone SMB to control the product purities and yields. The key idea is to match the target concentration wave velocity with the average port velocity for an ideal system. For non-ideal systems, flow rates are adjusted from those for ideal systems based on the theory and the intrinsic adsorption parameters, dispersion coefficients, intra-particle diffusivities, and zone lengths. After the intrinsic adsorption and mass transfer parameters are estimated and verified using small-column tests, the operating parameters are solved directly from coupled algebraic equations. This method was extended to nonlinear adsorption systems, and non-isocratic systems with thermal or pH gradients. A fast design and optimization method was also developed based on dimensionless groups, called the “Speedy Standing Wave Design” (SSWD) method. Fourteen decision variables can be optimized to achieve either maximum productivity, minimum solvent usage, or the lowest separation cost. This method was extended to nonlinear adsorption systems, and non-isocratic systems with thermal or pH gradients. A fast design and optimization method was also developed based on dimensionless groups, called the “Speedy Standing Wave Design” (SSWD) method. Fourteen decision variables can be optimized to achieve either maximum productivity, minimum solvent usage, or the lowest separation cost. The optimization calculations can be done in seconds using a laptop computer. By contrast, literature methods need millions of rate model simulations for search in the 9-parameter space. Since each simulation requires solving multiple coupled partial differential equations, an optimization problem can take days in a fast computer and there is no guarantee for finding the global optimal solution.

In the present novel technology, a general standing wave design method is developed for splitting an N-component mixture to produce two or more products in a multi-zone SMB, as explained below.

New multi-zone, multi-mode SMB fractionation of a complex mixture. The adsorbents in conventional SMB methods were based on functional groups in the stationary phase. A binary or ternary mixture was split into two products, raffinate or extract, in SMBs with three or four zones. The desorbent was the same as the solution or solvent for the feed components. The separation mechanisms were based on elution separation using a desorbent with constant composition, temperature, pH, ionic strength, or solvent strength.

In the instant novel technology, the functional groups can be present in the mobile phase or in the stationary phase. More than one desorbent can be employed to split a mixture into three fractions with high purities and high yields. In addition to a desorbent in the separation zones of elution separation, a second desorbent (or a stripping agent) can be employed in a separate zone to strip-off strongly adsorbed products or impurities in the stripping zone. The sorbents can be regenerated, washed, and re-equilibrated in separate zones. The multi-zone SMB can have more than four zones, which consists of stripping, washing, regeneration, and re-equilibration zone, in addition to elution or displacement separation zones. Two or more SMBs based on different sorbents can be designed in tandem for the fractionation of a complex mixture. We define here the new multi-zone, multi-mode SMB (called mSMB in short).

A new general design method for finding the operating zone velocities and port velocity for mSMB is developed and explained below. The general method is based on intrinsic adsorption and mass transfer parameters and equipment parameters and applies to various functional groups on the stationary phase or in the mobile phase. The separation mechanisms include size exclusion, hydrogen bonding, ion exchange, chelation, affinity, or a combination of the various mechanisms. The operating parameters which enable the production of high purity products with yields in mSMB can be found without empirical search in the multi-dimensional design parameter space. The new design method was verified with VERSE simulations or experimental data in the Examples. A column prefill strategy is also developed to shorten the SMB start-up period to a few steps, while conventional SMB start-up (with clean columns) requires 3 cycles or more to reach a cyclic steady state.

Standing Wave Design Methods for mSMB. Some new sorbents are selective for Li based on functional groups which have high affinity for Li or special sorbent structures which exclude large divalent ions and prefer the adsorption of Li. Examples include lithium-aluminum layered double hydroxide chloride, titanium zirconium phosphate, and the like. However, these sorbents are costly or unavailable at large quantities at this time. Most commercially available sorbents offer a higher selectivity for divalent ions like Ni, Co, and Mn rather than for Li. Examples of such sorbents include metal oxides, zirconium phosphate, zeolites, and sorbents with chelating functional groups, including aminopolycarboxylic acids, citric acid, and bispicolylamine, and the like and combinations thereof.

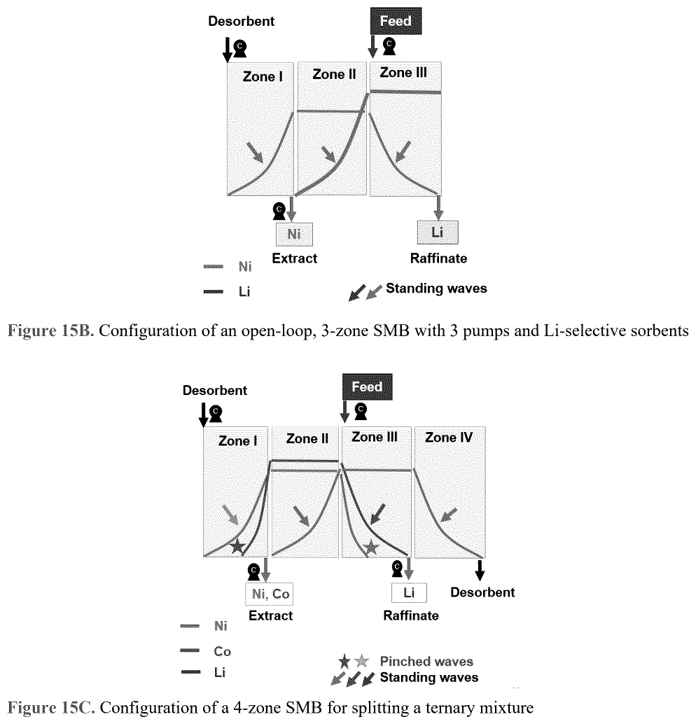

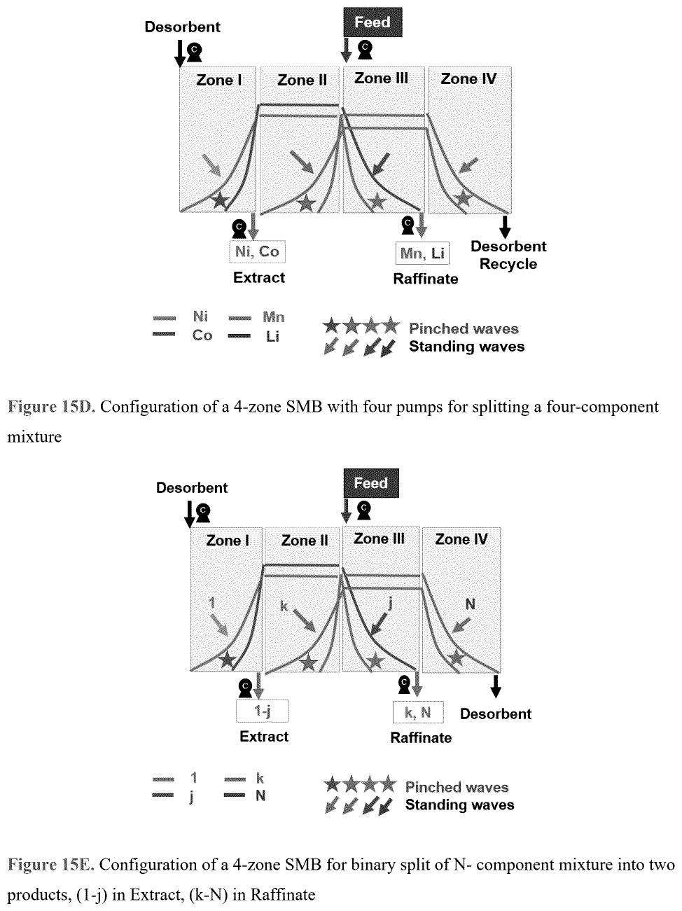

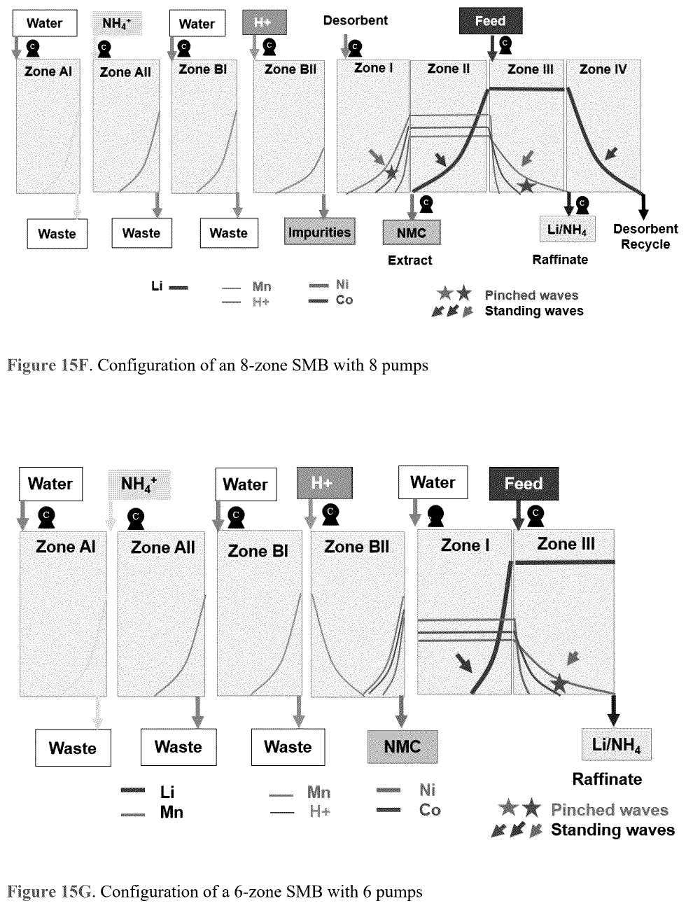

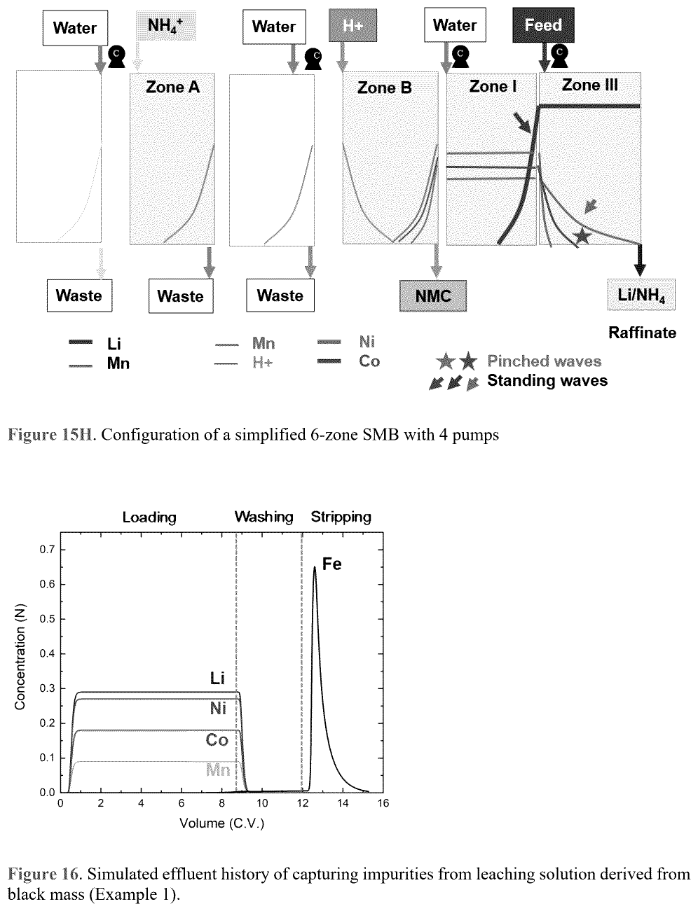

Mixtures of Li, Ni, Co, Mn (LiNMC in short) can be split into two groups in a three zone or a four-zone SMB. An example for splitting a binary mixture of Li and Ni into two products to produce high purity Li in the raffinate and high purity Ni in the extract is shown in FIG. 15A. In certain applications, if there is no need to recycle or reuse the desorbent, the three-zone open-loop SMB is simpler to design and operate than a four-zone SMB (see FIG. 15B). Splitting a ternary mixture of Ni, Co, and Li into two products to produce Ni and Co in the Extract and Li in the Raffinate is shown in FIG. 15C.

Method for mSMB: 4-Zone SMB

A four-zone SMB based on a size-exclusion sorbent, an inorganic sorbent, or a chelating agent in the mobile phase, which results in a slower migration velocity of Ni than that of Li in the column, can be designed for the separation of Li and Ni in a close-loop 4-zone SMB or a 3-zone open-loop SMB, where the desorbent is not recycled. In certain applications, if there is no need to recycle or reuse the desorbent, the 3-zone open-loop SMB is simpler to design and operate than a 4-zone SMB.

In a continuous moving bed, if wave spreading is negligible (defined as an ideal system), such as in a system with a few micron sorbent particles, one can simply match the port velocity to the key wave migration velocities in the respective zones. The key waves are (1) the desorption wave of the slow-moving solute Ni in Zone I, (2) the desorption wave of the fast-moving solute Li in Zone II, (3) the adsorption wave velocity of the slow-solute Ni in Zone III, and (4) the adsorption wave of the fast-solute Li in Zone IV. For linear systems with constant wave migration velocities, for example, size exclusion systems or systems with linear adsorption isotherms, the wave velocity of component i in Zone j u_{w,i}^{j} is related to the interstitial velocity in Zone j, u₀^{j}, the phase ratio P, which is defined as the ratio of the particle volume fraction (1-ε_{b}) to the bed void fraction (ε_{b}), and an apparent retention factor δᵢ.

$${u}_{w , Ni}^{I} = v \qquad ( 15 a )$$

$${u}_{w , Li}^{II} = v \qquad ( 15 b )$$

$${u}_{w , Ni}^{III} = v \qquad ( 15 c )$$

$${u}_{w , Li}^{IV} = v \qquad ( 15 d )$$

where the subscripts Ni denote the slow migrating solute and Li the fast migrating solute, respectively; the superscripts I, II, III, and IV denote the four zones; u_{w,i}^{j} is the wave velocity of standing component i in Zone j; v is the port moving velocity in CMB; For SMB, an average port velocity is defined as v=(column length L_{c})/(switching time or step time tₛ); u₀^{j} is the interstitial velocity in Zone j. The effective retention factors (d) for the multi-component Langmuir isotherm systems are calculated from isotherm parameters (aᵢ and bᵢ), particle porosity εₚ, and extra-column dead volume (DV).

The retention factor (δᵢ^{j}) is calculated from isotherm parameters (aᵢ and bᵢ), particle porosity εₚ, and extra-column dead volume (DV). The retention factor is related to εₚ, and the effective Langmuir adsorption parameter aᵢ^{j}.

$${δ}_{i}^{j} = {ε}_{p} + ( 1 - {ε}_{p} ) {a}_{i}^{j} + \frac{DV}{{PL}_{c} S {ε}_{b}} \qquad ( 15 e )$$

For linear isotherm systems (bi=0), the value aᵢ^{j} is a constant. For non-linear systems, aᵢ^{j} can be estimated from the experimental or simulated elution chromatogram of a long pulse of a multi-component mixture. Alternatively, aᵢ^{j} can also be estimated from multi-component chromatography theory if the Langmuir parameters aᵢ and bᵢ are known. System dead volume DV can contribute to an increase in δᵢ^{j}, as in Eq. (15e), where S is the column cross-sectional area. In addition to Eq. (15), mass balance at the inlet of Zone III, must be satisfied, resulting in

$$\frac{{Q}_{feed}}{{ε}_{b} S} = {u}_{0}^{III} - {u}_{0}^{II} = {u}_{0}^{F} \qquad ( 16 )$$

where Q_{feed} is the feed flow rate and u₀^{F} is defined here as the feed velocity. Notice that equations (15) to (16) are defined in terms of linear velocities, so that these equations and the solutions can be applied to different column diameters or lengths.

For an ideal system, there are six unknowns (4 zone velocities, port velocity, and feed velocity) to be solved with five equations. In order to have a unique solution, one parameter needs to be fixed. If feed velocity is fixed, the five equations, Eq. (15a-d) and Eq. (16), can be used to solve the five SMB operating parameters, u₀^{I}, u₀^{II}, u₀^{III}, u₀^{IV}, and v. If port velocity is fixed, the five equations can be solved for the feed velocity and the four zone velocities.

### Non-Ideal Standing Wave Design Method for the Separation of a Binary Mixture in 4-Zone SMB

For a non-ideal system, where wave spreading is significant, the interstitial velocities in Zone I and Zone II can be adjusted such that the key wave velocities in these two zones are larger than the port velocity, whereas the key wave velocities in Zone III and Zone IV are smaller than the port velocity. The differences in the wave velocity and the port velocity can focus the key wave in each zone, such that the key waves remain confined in the respective zones at cyclic steady state. The adjustment in the interstitial velocity for each zone was derived previously for linear, non-ideal systems as follows:

$${u}_{0}^{I} = ( 1 + P {δ}_{Ni}^{I} ) v + \frac{{β}_{Ni}^{I}}{{L}^{I}} ( {E}_{b , Ni}^{I} + \frac{P {{v}^{2} ( {δ}_{Ni}^{I} )}^{2}}{{K}_{f , Ni}^{I}} ) \qquad ( 17 a )$$

$${u}_{0}^{II} = ( 1 + P {δ}_{Li}^{II} ) v + \frac{{β}_{Li}^{II}}{{L}^{II}} ( {E}_{b , Li}^{j} + \frac{P {{v}^{2} ( {δ}_{Li}^{II} )}^{2}}{{K}_{f , Li}^{II}} ) \qquad ( 17 b )$$

$${u}_{0}^{III} = ( 1 + P {δ}_{Ni}^{III} ) v - \frac{{β}_{Ni}^{III}}{{L}^{III}} ( {E}_{b , Ni}^{j} + \frac{P {{v}^{2} ( {δ}_{Ni}^{III} )}^{2}}{{K}_{f , Ni}^{III}} ) \qquad ( 17 c )$$

$${u}_{0}^{IV} = ( 1 + P {δ}_{Li}^{IV} ) v - \frac{{β}_{Li}^{IV}}{{L}^{IV}} ( {E}_{b , Li}^{j} + \frac{P {{v}^{2} ( {δ}_{Li}^{IV} )}^{2}}{{K}_{f , Li}^{IV}} ) \qquad ( 17 d )$$

$$\frac{{Q}_{feed}}{{ε}_{b} S} = {u}_{0}^{III} - {u}_{0}^{II} = {u}_{0}^{F} \qquad ( 17 e )$$

$$where$$

$${β}_{i}^{J} = ln \frac{1 - θ}{θ}$$

is a function of the cut θ. For θ=0.001, yields of the products are 99% or higher. Lⱼ is the length of Zone j. E_{b,i}^{j} is the axial dispersion coefficient of i in Zone j, which can be estimated from the Chung and Wen correlation. For diffusion-controlled systems, the overall mass transfer coefficient K_{f} can be estimated from the characteristic diffusion time t_{D}

$$\frac{1}{{K}_{f}} = \frac{{R}_{p}^{2}}{15 {ε}_{p} {D}_{p}} = \frac{{t}_{D}}{15} \qquad ( 17 f )$$

The axial dispersion coefficient is dependent on the interstitial mobile phase velocity according to the Chung and Wen correlation. If axial dispersion effects are important, one can iteratively solve for the four zone velocities and the feed velocity from the four zone lengths L^{j}, port velocity v, βᵢ^{j} (or yields), P, δᵢ^{j}, and K_{f,i}^{j}. If the port velocity is not fixed, one can solve for the four zone velocities and the maximum feed flow rate for the given zone lengths. If the column length and the total number of columns are fixed, one can incorporate the five SWD equations in an optimization program to optimize the feed flow rate or the column configuration (the number of columns in each zone) to achieve maximum productivity, minimum desorbent consumption, or lowest purification cost.

If there is no need for desorbent recycle, Zone IV in FIG. 15A can be omitted, as shown in FIG. 15B. In this case only three pumps are needed and the design equations for the 4-zone SMB can be modified accordingly for the 3-zone SMB.

Non-Ideal Standing Wave Design Method for the Separation of a Multi-Component Mixture into Two Products in a 4-Zone SMB

An example of splitting a ternary mixture of Ni, Co, and Li into two products to produce a high-purity Li with a high yield in the Raffinate and a mixture of Ni and Co with a high yield in the Extract is shown in FIG. 15C. To ensure the high-purity and high-yield separation, one can confine the desorption wave of Ni in Zone I, the desorption wave of Li in Zone II, the adsorption wave of Co in Zone III, and the adsorption wave of Li in Zone IV. Notice that in this method, the adsorption wave of Co in Zone I, which migrates faster than that of Ni will be automatically focused or “pinched” toward the boundary between Zone I and Zone II. Similarly, the adsorption wave of Ni in Zone III, which migrates more slowly than that of Co in Zone III, will be “pinched” in the region between Zone II and Zone III. The standing components in the SWD equations, Eq. (17), can be modified accordingly. The operating parameters solved from the SWD equations can ensure high purities and high yields of both the Raffinate and the Extract.

Splitting of a 4-component mixture of Ni, Co, Mn, and Li, into two products, Ni and Co in the Extract and Mn and Li in the Raffinate, is shown in FIG. 15D. To ensure high purity and high-yield split, the desorption wave of Ni is confined in Zone I, the desorption wave of Mn is confined in Zone II, the adsorption wave of Co is confined in Zone III, and the adsorption wave of Li is confined in Zone IV. Notice that the desorption wave of Co, which migrates faster than Ni, is pinched toward the boundary between Zone I and Zone II; the desorption wave of Li, which migrates faster than Mn, is pinched toward the boundary between Zone II and Zone III; the adsorption wave of Ni, which migrates more slowly than that of Co, is pinched toward the boundary between Zone II and Zone III; the adsorption wave of Mn, which migrates more slowly than Li, is pinched toward the boundary between Zone III and Zone IV. In this method, Ni and Co are recovered in the Extract and Mn and Li are recovered in the Raffinate with high yields.

This design strategy can be generalized for the separation of a mixture of N components into an Extract products containing component 1 through j and a Raffinate product containing component k through N, as shown in FIG. 15E. To ensure high purity and high-yield split, the desorption wave of component 1 is confined in Zone I, the desorption wave of component k is confined in Zone II, the adsorption wave of component j is confined in Zone III, and the adsorption wave of component N is confined in Zone IV. Notice that the desorption waves of components 2 to j, which migrate faster than component 1, is pinched toward the boundary between Zone I and Zone II; the desorption waves of component k+1 through N, which migrate faster than component k, are pinched toward the boundary between Zone II and Zone III; the adsorption waves of 1 through j−1, which migrate more slowly than that of component j, is pinched toward the boundary between Zone II and Zone III; the adsorption waves of component k to N−1, which migrate more slowly than component N, are pinched toward the boundary between Zone III and Zone IV. The standing waves and the pinched waves of FIGS. 15A to 15E are listed in Table 2A.

The SWD equations for non-ideal systems for splitting an N-component mixture are listed below.

$${u}_{0}^{I} = ( 1 + P {δ}_{1}^{I} ) v + \frac{{β}_{1}^{I}}{{L}^{I}} ( {E}_{b , 1}^{I} + \frac{P {{v}^{2} ( {δ}_{1}^{I} )}^{2}}{{K}_{f , 1}^{I}} ) \qquad ( 18 a )$$

$${u}_{0}^{II} = ( 1 + P {δ}_{k}^{II} ) v + \frac{{β}_{k}^{II}}{{L}^{II}} ( {E}_{b , k}^{II} + \frac{P {{v}^{2} ( {δ}_{k}^{II} )}^{2}}{{K}_{f , k}^{II}} ) \qquad ( 18 b )$$

$${u}_{0}^{III} = ( 1 + P {δ}_{J}^{III} ) v - \frac{{β}_{j}^{III}}{{L}^{III}} ( {E}_{b , j}^{III} + \frac{P {{v}^{2} ( {δ}_{j}^{III} )}^{2}}{{K}_{f , j}^{III}} ) \qquad ( 18 c )$$

$${u}_{0}^{IV} = ( 1 + P {δ}_{N}^{IV} ) v - \frac{{β}_{N}^{IV}}{{L}^{IV}} ( {E}_{b , N}^{IV} + \frac{P {{v}^{2} ( {δ}_{N}^{IV} )}^{2}}{{K}_{f , N}^{IV}} ) \qquad ( 18 d )$$

$$\frac{{Q}_{feed}}{{ε}_{b} S} = {u}_{0}^{III} - {u}_{0}^{II} = {u}_{0}^{F} \qquad ( 18 e )$$

The five SWD equations for the split of an N-component mixture can be used to solve for five unknown operating parameters. If the port velocity, column length, and the zone lengths are fixed, one can solve for the four zone velocities and the feed velocity. If the feed velocity is fixed, one can solve for the port velocity and the zone velocities. If the SMB equipment has a fixed column length, column diameter, and a fixed number of columns, one can incorporate the five SWD equations in an optimization routine to optimize the zone configuration to achieve high sorbent productivity, low desorbent cost, or low overall purification cost.

TABLE 2A
Standing Concentration Waves and Pinched Concentration Waves in 4-zone SMB

| Fig. | | Zone I | Zone II | Zone III | Zone IV |
|---|---|---|---|---|---|
| 15A | Aim | Confine Ni desorp wave | Confine Li desorp wave | Confine Ni adsorp wave | Confine Li adsorp wave |
| | Goal | High Ni yield in extract | High Li yield in raffinate | High Ni yield in extract | Recycle desorbent |
| | SW | Ni | Li | Ni | Li |
| | PW | N/A | N/A | N/A | N/A |
| 15B | Aim | Confine Ni desorp wave | Confine Li desorp wave | Confine Ni adsorp wave | N/A |
| | Goal | High Ni yield in extract | High Li yield in raffinate | High Ni yield in extract | N/A |
| | SW | Ni | Li | Ni | N/A |
| | PW | N/A | N/A | N/A | N/A |
| 15C | Aim | Confine Ni desorp wave | Confine Li desorp wave | Confine Co adsorp wave | Confine Li adsorp wave |
| | Goal | High Ni and Co yield in | High Li yield in raffinate | High Ni and Co yield in | Recycle desorbent |
| | | extract | | extract | |
| | SW | Ni | Li | Co | Li |
| | PW | Co | N/A | Ni | N/A |
| 15D | Aim | Confine Ni desorp wave | Confine Mn desorp wave | Confine Co adsorp wave | Confine Li adsorp wave |
| | Goal | High Ni and Co yield in | High Li and Mn yield in | High Ni and Co yield in | Recycle desorbent |
| | | extract | raffinate | extract | |
| | SW | Ni | Mn | Co | Li |
| | PW | Co | Li | Ni | Mn |
| 15E | Aim | Confine 1 to j desorp | Confine k to N desorp | Confine 1 to j adsorp | Confine k to N adsorp |
| | | waves | waves | waves | waves |
| | Goal | High 1 to j yield in | High k to N yield in | High 1 to j yield in | Recycle desorbent |
| | | extract | raffinate | extract | |
| | SW | 1 | k | i | N |
| | PW | 2 to j | k₊₁ to N | j₋₁ to 1 | N₋₁ to k |

SWD Method for Splitting an N-Component Mixture in Multi-Zone SMB (mSMB) with the Separation Zones Coupled with Stripping and Re-Equilibration Zones

The desorbent in the 4-zone SMB is the same solvent for dissolving the feed mixtures. The components are separated into two products via isocratic elution in the 4-zone SMB. Fast moving solutes are recovered in the Raffinate, while slow moving solutes are recovered in the Extract. If the feed contains impurities and the sorbent has much higher affinity for the impurities than for Ni, Co, Mn, and Li, one can couple the impurity removal and column regeneration processes with the fractionation process in the 4-zone SMB in a continuous 8-zone SMB, as shown in FIG. 15F.

Li is separated from NMC in Zone I to Zone IV. The column with strongly adsorbed impurities is then moved to the stripping Zone, BII. A stripping agent is used to strip the strongly adsorbed impurities; the column is then moved to a water washing Zone BI. A presaturant is then loaded in Zone AII and the column is washed with water in Zone AI to remove the non-adsorbed presaturant. The preequilibrated column from Zone AI is then moved to Zone IV. The 4-zone SMB section for binary split of Li and NMC can be designed as explained previously. The stripping and the regeneration zones can be designed to have the same step time as that of the 4-zone SMB. This mSMB with 8 zones will require 8 pumps and 16 columns if each zone has 2 columns.

Sorbents with chelating functional groups, such as bispicolylamine, imino-diacetic acid or other amino-polycarboxylic acid functional groups, are much more selective for Ni, Co, and Mn than for Li. If an isocratic elution 4-zone SMB based on a chelating sorbent is designed for separating Li from NMC, the NMC in the Extract will be diluted many times and the sorbent has a low productivity (see Example 8).

A 6-zone SMB based on a resin with IDA functional groups is shown in FIG. 15G. In this new design, the strongly adsorbed solutes NMC are stripped in Zone BII. Zone I which is loaded with the feed is washed with water (or a weak desorbent) in Zone I to confine the desorption wave of Li in Zone I so that no loss of Li to the stripping Zone. There is no need for Zone II, since the slow-moving solutes NMC are recovered in the stripping Zone BII. Feed is added between Zone I and Zone III. The adsorption wave of Mn is confined in Zone III, so that the adsorption waves of Co and Ni are pinched between Zone I and Zone III and no loss of NMC to the Raffinate. Zone IV is omitted, since there is no desorbent recycle. If the port velocity is fixed, the feed velocity and the Zone I and Zone III velocities are determined from the standing wave equations to achieve high purity products with high yields.

This 6-zone design in FIG. 15G requires 6 pumps and the columns have six inlet options, whereas most of the laboratory-scale SMBs have only four pumps and four inlet/outlet options. The design in FIG. 15G can be further simplified to 4 zones with 4 pumps, as shown in FIG. 15H. To reduce the number of pumps, Zones BI and BII are combined to share one pump. Zones AI and AII are combined to share one pump. The design in FIG. 15H was tested in a laboratory scale SMB, and detailed results are reported in Example 9. Standing waves and the pinched waves of FIG. 15F to 15H are listed in Table 2B.

TABLE 2B
Standing waves and pinched waves in multi-zone SMB

| FIG. | Zone | AI | AII | BI | BII | I | II | III | IV |
|---|---|---|---|---|---|---|---|---|---|
| 15F | Aim | N/A | N/A | N/A | N/A | Confine Ni | Confine Li | Confine | Confine Li |
| | | | | | | desorp | desorp | Mn adsorp | adsorp |
| | | | | | | wave | wave | wave | wave |
| | Goal | Wash out | Convert | Wash out | Strip | High NMC | High Li | High NMC | Recycle |
| | | residual | resin to | residual H | impurities | yield in | yield in | yield in | desorbent |
| | | NH₄ | NH₄ form | | | extract | raffinate | extract | |
| | SW | N/A | N/A | N/A | N/A | Ni | Li | Mn | Li |
| | PW | N/A | N/A | N/A | N/A | Co, Mn | N/A | Ni, Co | N/A |
| 15G | Aim | N/A | N/A | N/A | N/A | Confine Li | N/A | Confine | N/A |
| | | | | | | desorp | | Mn adsorp | |
| | | | | | | wave | | wave | |
| | Goal | Wash out | Convert | Wash out | Strip NMC | High NMC | N/A | High Li | N/A |
| | | residual | resin to | residual H | | yield in | | yield in | |
| | | NH₄ | NH₄ form | | | zone B | | raffinate | |
| | SW | N/A | N/A | N/A | N/A | Li | N/A | Mn | N/A |
| | PW | N/A | N/A | N/A | N/A | N/A | N/A | Ni, Co | N/A |
| 15H | Aim | N/A | N/A | N/A | N/A | Confine Li | N/A | Confine | N/A |
| | | | | | | desorp | | Mn adsorp | |
| | | | | | | wave | | wave | |
| | Goal | Convert to | N/A | Strip NMC | N/A | High NMC | N/A | High Li | N/A |
| | | NH₄ form | | and wash | | yield in | | yield in | |
| | | and wash | | out residual | | Zone B | | raffinate | |
| | | out residual | | H | | | | | |
| | | NH₄ | | | | | | | |
| | SW | N/A | N/A | N/A | N/A | Li | N/A | Mn | N/A |
| | PW | N/A | N/A | N/A | N/A | N/A | N/A | Ni, Co | N/A |

### EXAMPLES

### Example 1: Capture of Impurities from Leaching Solution Derived from LIBs Black Mass

Black mass is derived from waste LIBs, and contains graphite, carbon black, active cathode materials, as well as trace amounts of other metal oxides impurities. Graphite and carbon black can be separated from metal oxides using physical separation methods based on different densities and/or particle sizes. Metal oxides can be converted to soluble salts through an acid leaching step. The leaching solution is a mixture of target products, Li, Mn, Co, and Ni, as well as a trace amount of impurities such as Fe, Cu, Al. Removal of these impurities is helpful. These impurities have a higher affinity to HDEHP impregnated resin, iminodiacetic acid (IDA) resin, or amino-methyl phosphonic (AMP) resin than the target elements. Constant pattern capture design method is applied for capturing impurities from the leaching solution.

A leaching solution containing 0.29 N Li, 0.09 N Mn, 0.18 N Co, 0.27 N Ni, and 0.05 N Fe (as a synthetic leaching solution containing Fe as a representative impurity) was prepared. A laboratory-scale batch process for capturing the impurities was designed according to the constant-pattern design detailed above. A 50 cm column with 1.5 cm diameter glass columns was packed with HDEHP impregnated resin. Li, Mn, Co, and Ni are non-adsorbing while Fe is strongly adsorbed. The feed was loaded into the column at a flowrate of 1.5 mL/min (2.43 cm/min). The impurities were captured in the column. Simulated effluent history from the capture column is shown in FIG. 16.

The effluent histories are the mirror images of column profiles. The impurity, which has the highest affinity for the resin, was captured and concentrated in the column. A washing step was used after the loading to ensure the capture of the impurities in the column void and to wash out non-adsorbing components. A dilute acid was used to strip off the impurities from the column and regenerate the column.

As shown in the effluent histories of this capture process (see FIG. 16) the non-adsorbing components, Li, Mn, Co, and Ni started breakthrough at the void volume (0.5 C.V.). An impurity-free Li, Mn, Co, and Ni mixed product was collected between 0.5 and 9 C.V. All the captured Fe was stripped off in the acid stripping step. The column was then washed with water and reused in the capture process.

### Example 2: Capture of Mg2+ from Mg/Li Binary Mixture to Produce a High-Purity Li Product

In the recovery of Li from Li-rich brines, the majority of the impurities, Na and K, which have lower solubilities than Mg and Li, precipitate during solar evaporation. The supernatant containing Mg and Li is recovered for further purification.

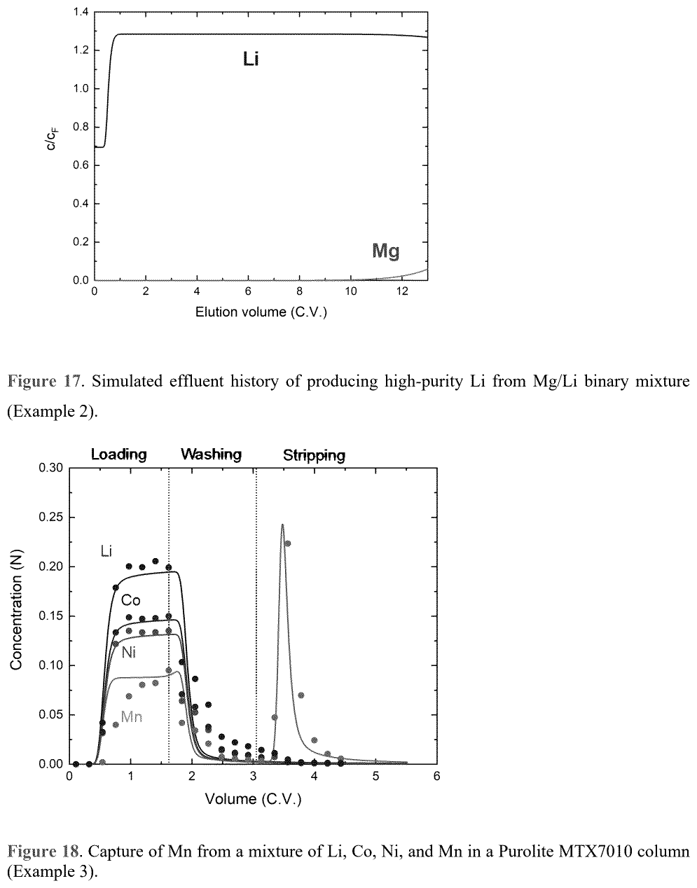

A binary Mg/Li solution with a similar composition as the brine found in Clayton Valley, US was used as a feedstock, which contained 0.144 N Li and 0.041 N Mg. Glass columns were packed with Purolite MTS9320 (IDA) resin, with a selectivity of Mg over Li of 10, uniform particle diameter of 620 μm and a capacity of 1.5 meq./mL (PUROLITE is a registered trademark of Purolite Corporation of DELAWARE, 2201 Renaissance Blvd., Suite 400 King of Prussia PENNSYLVANIA 19406, reg. no. 4313122, Jan. 15, 2013). A 50 cm column with 1.5 cm diameter was packed with the resin pre-equilibrated with Li. The feed was loaded into the column at a flowrate of 1.5 mL/min (2.43 cm/min). Mg ions were captured in the column. High purity Li salt was produced from the effluent (0.5 CV to 10 CV). The simulated effluent history is shown in FIG. 17. After 10 CV loading, the captured Mg was stripped off by using a weak acid. The column was washed with water to remove any residual acid and reused in the batch capture process.

Alternatively, a continuous carousel capture process (see Example 4) may be designed according to the Detailed Method.

### Example 3: Tandem Capture for Recovering High Purity Li, Mn, Co, and Ni from the Black Mass Derived from Waste LIBs

Capture of Mn. A leaching solution was derived from waste LIBs cathode material. It contained 0.2 N Li, 0.14 N Mn, 0.15 N Co, and 0.135 N Ni. The pH of the leaching solution was adjusted to 2.5. A column (17.5 cm in length and 1.16 cm in diameter) was packed with Purolite MTX7010 resin (macroporous polystyrene divinylbenzene impregnated with HDEHP). The leaching solution was loaded into the column at a superficial velocity of 0.946 cm/min until full saturation. The column was then washed using 1.5 C.V. of DI water followed by stripping with 0.5 M HCl. The effluent was collected in fractions and analyzed using ICP. The effluent history is given in FIG. 18. Only Mn was adsorbed in the column. A high purity Mn product was collected during the acid stripping step. If the capture column is sufficiently long, a Mn-free fraction can be collected during the loading and washing step.

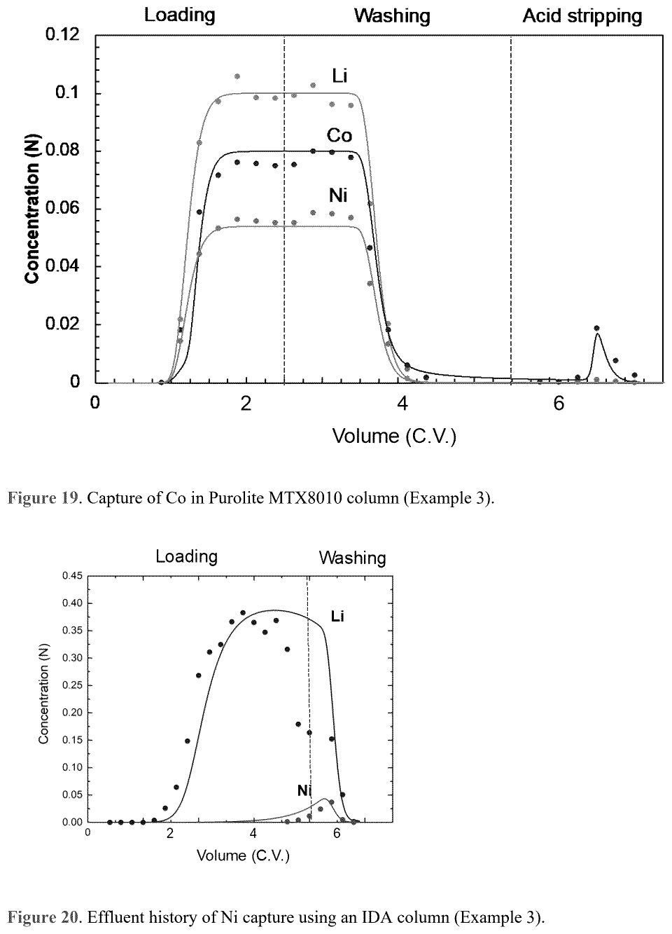

Capture of Co. A simulated Mn-free mixture of Li, Ni, and Co chloride salts (Li: 0.1 N, Ni: 0.054 N, Co: 0.08 N) was prepared, and the solution pH was around 3.5. NaOH solution was used to titrate the solution pH to 4.5. The solution was continuously stirred, and the pH was stable at 4.5 for 20 min. This mixture was used as the feed to the column to estimate Co capacity. The feed was loaded into the column at a superficial velocity of 0.946 cm/min until full saturation. The column was then washed using 1.5 C.V. of DI water followed by stripping with 0.5 M HCl. The effluent was collected in fractions and analyzed using ICP. The effluent history was shown in FIG. 19. Only Co was adsorbed in the column. A high purity Co product was collected during an acid stripping step. If the capture column is sufficiently long, a Co-free fraction can be collected during loading and washing step.
Capture of Ni. A Co-free simulant containing only Li and Ni was prepared. A column was packed with Purolite MTS9300 (IDA resin). The feed was loaded into the column at a superficial velocity of 0.946 cm/min. The effluent was collected in fractions and analyzed using ICP. The effluent history was shown in FIG. 20. Only Ni was captured in the column, and high purity Li product was collected in the early eluting fractions, 1.8-4.0 C.V.

### Example 4. Carousel Capture for Recovering High Purity Metal Salts from Complex Mixtures

### Example 4.1 Carousel Capture for Recovering High Purity Li from a Li/Ni Binary Mixture

A three-segment carousel was designed to continuously capture Ni from a Ni/Li binary mixture with similar composition to the feed solution in the last step in Example 3 (0.25 N Li, 0.15 N Ni). Each segment has a column length of 51 cm and a diameter of 5 cm. The total column length is 153 cm. The columns were packed with AmberSep IRC748 resin (IDA, 575 μm) (AMBERSEP is a registered trademark of Rohm and Haas Company CORPORATION of DELAWARE, 100 Independence Mall W., Philadelphia, PENNSYLVANIA, 191052399, reg. no. 1186259, Jan. 19, 1982).

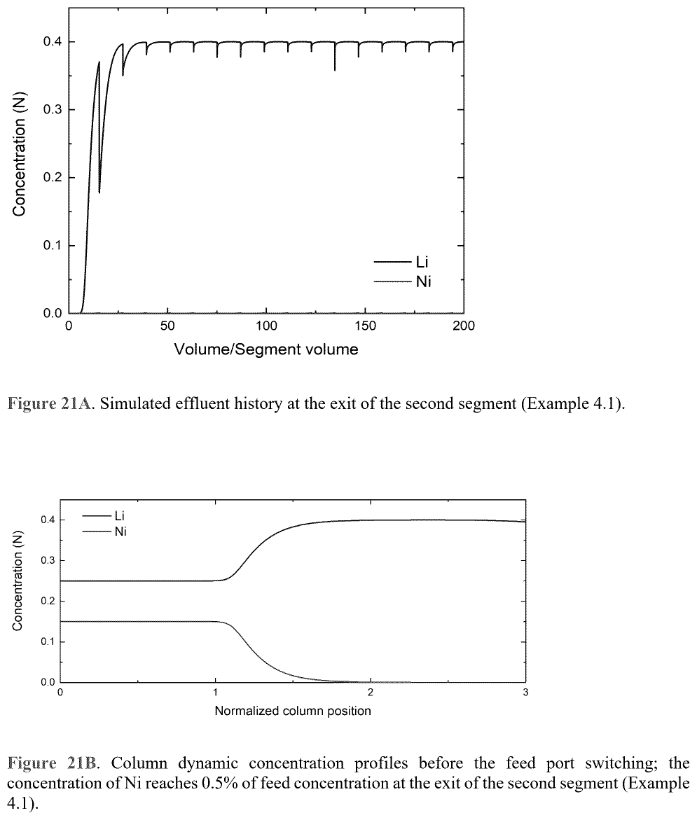

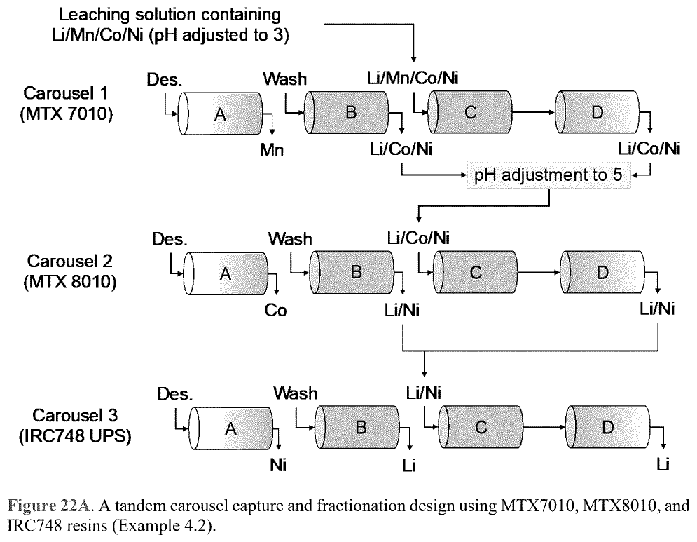

The design of the carousel ensures the formation of constant pattern concentration wave of Ni within two segments. To ensure a high purity Li product (>99.9%), one can switch the feed port when the concentration of Ni reached 0.5% of the feed concentration at the exit of the second segment. The effluent history at the exit of the second segment is shown in FIG. 21A. The second segment can always contain the constant mass transfer zone after cyclic steady state because of the formation of constant pattern. The column dynamic concentration profile before the feed port switching is shown in FIG. 21B. The third segment was used for regeneration. The saturated segment was stripped rapidly using a dilute acid (0.5 M HCl). High purity Li product was collected at the outlet of the second segment in each cycle, and high purity Ni product was collected during the stripping of the saturated segment.

### Example 4.2 Tandem Carousel Capture and Fractionation for Recovering High Purity Metal Salts from Waste Lithium-Ion Battery Leaching Solutions

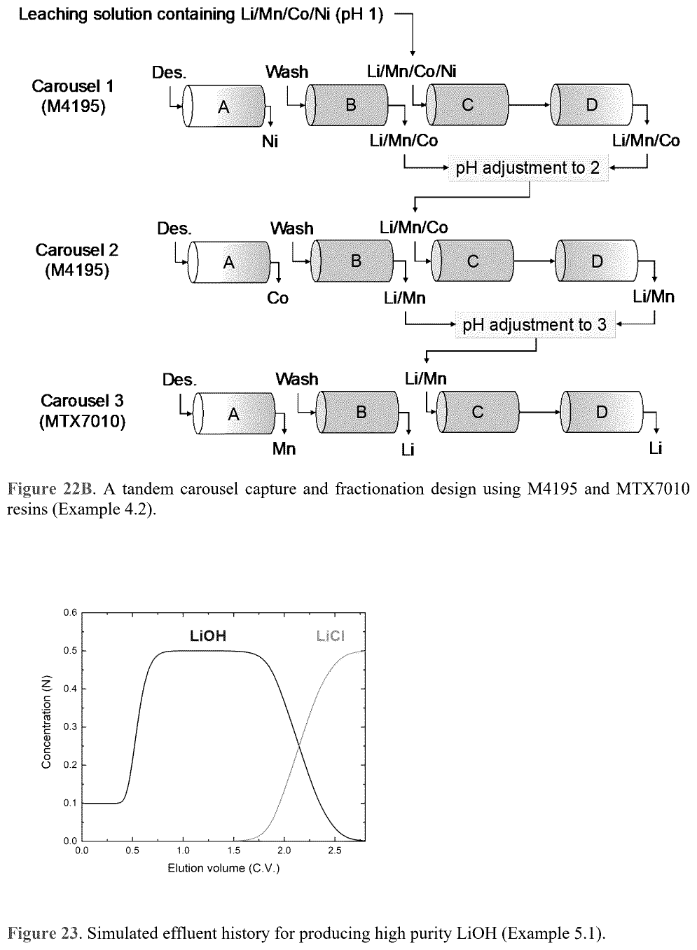

Two tandem carousel capture and fractionation processes are designed for recovering individual high purity metal salts from waste lithium-ion battery leaching solutions, as shown in FIGS. 22A and 22B.

The first tandem carousel capture and fractionation process (FIG. 22A) is designed based on the single-column tandem capture process in Example 3. The first carousel in this process, where MTX7010 is used as the sorbent, can effectively capture Mn from a leaching solution with pH adjusted to 3. Mn is recovered as a high purity salt after stripping from the saturated segment using a dilute acid (pH 1). Non-adsorbing Li, Co, and Ni will be collected during the loading and washing steps. The collected ternary solution is adjusted to pH 5 before fed into the second carousel, where MTX8010 is used for effective Co capture. Co can be stripped from the saturated segment as a high purity product. Non-adsorbing Li and Ni are collected during the loading and washing steps and are separated in the third carousel, where IDA resin is used to capture Ni.

The second example of tandem carousel capture and fractionation process (FIG. 22B) uses M4195 and MTX7010 resins. M4195 is a chelation resin with bis-picolylamine functional groups. The adsorption of metal ions strongly depends on the solution pH. At pH 1, M4195 resin adsorbs Ni ions while other metal ions such as Li, Mn, and Co are non-adsorbing. At pH 2, Co strongly adsorbs while Li and Mn are non-adsorbing. The first two carousels in this tandem carousel design utilizes this pH dependent adsorption. Leaching solution at pH 1 is used as the feed to Carousel 1, in which Ni is captured and stripped as a high purity salt. The ternary mixture of Li, Mn, and Co from Carousel 1 is introduced into the second carousel (Carousel 2) after pH is adjusted to 2. Co is captured and recovered as a high purity product from this ternary mixture. In the final carousel (Carousel 3), MTX7010 is used to separate Li and Mn into two high purity salts.

After desorption of the captured solute, if washing or pre-equilibration is needed before loading, more segments can be added into the carousel systems. Compared to tandem capture process using single columns and batch operation, tandem capture process can continuously produce high purity product and greatly improve column capacity utilization and productivity.

### Example 5. Exchange of Chloride or Sulfate Ions with Hydroxide Ions to Produce High Purity LiOH Product

Type I anion exchange resin (trimethylammonium functional group) has the lowest affinity for OH ions. When high purity lithium sulfate or chloride salt is loaded into the anion exchange column pre-equilibrated with OH ions, sulfate or chloride ions will be retained in the column and OH ions are displaced and co-elute with cation Lit. High purity LiOH was produced.

### Example 5.1. Exchange of Chloride with Hydroxide Ions to Produce LiOH

In this example, AmberLite HPR9000 OH ion exchange resin was used. The sorbent was macroporous type I anion exchange resin with a uniform particle diameter of 650 μm and a capacity of 0.8 meq./mL. A 50 cm column with 1.5 cm diameter was packed with the sorbent. The feed, 0.5 N LiCl solution, was loaded into the column at a flowrate of 1 mL/min (1.62 cm/min). High purity (99.5%) LiOH was produced. The simulated effluent history is shown in FIG. 23.

### Example 5.2. Producing Li₂CO₃ from a Mixture of Li₂SO₄ and (NH₄)₂SO₄

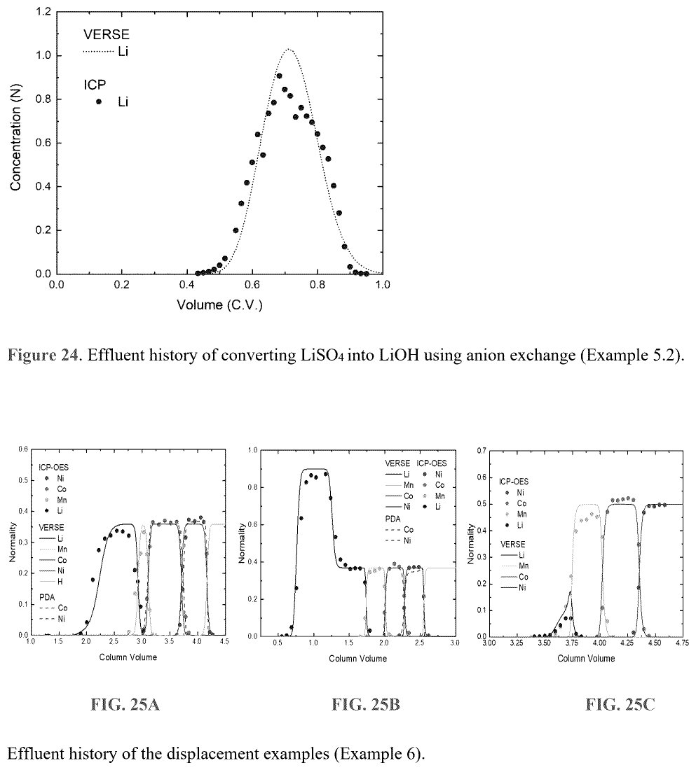

In this example, Three Omnifit columns with an I.D. of 2.5 cm were packed with Amberlite HPR9200 resin (640 μm, macroporous, Type I anion exchange) and were converted to OH form (AMBERLITE is a registered trademark of DDP SPECIALTY ELECTRONIC MATERIALS US 8, LLC, LIMITED LIABILITY COMPANY of DELAWARE, 974 CENTRE ROAD, WILMINGTON, DELAWARE, 19805, reg. no. 0257757, Feb. 23, 1989; OMNIFIT is a registered trademark of DIBA INDUSTRIES LIMITED CORPORATION of the UNITED KINGDOM, CAMBRIDGE, CAMBRIDGESHIRE, UNITED KINGDOM, CB1 3HD, reg. no. 1167022, Sep. 1, 1981). The final length of three columns were 38 cm, 41 cm, and 41 cm, respectively. a mixture of Li₂SO₄ and (NH₄)₂SO₄ was used as the feed to the anion exchange columns. The feed contained 1.29 N Li⁺, 0.71 N NH₄⁺, and 2.0 N SO₄²⁻. 100 mL of the feed solution was loaded into the column at a flowrate of 2.5 mL/min. The column was then washed with 600 mL (1 C.V.) of water. The effluent was collected in 10 mL fractions and each fraction was analyzed using ICP-OES to determine the Li⁺ and SO₄²⁻ concentrations. The effluent history is shown in FIG. 24. The simulation parameters were listed in Table 3. All the Li was collected without SO₄²⁻ contamination, indicating complete conversion from sulfate to hydroxide. The fractions containing Li were collected in a beaker and the solution was boiled for an hour by using a hotplate to remove NH₄OH. Excess CO₂ gas (10 scfh, 6 hrs) was bubbled into the solution to convert LiOH to Li₂CO₃. The resulting solution was placed on a hotplate to evaporate all the water and to produce a solid Li₂CO₃ product. A sample pf 0.5 g of the solid product was collected and dissolved in 50 mL of 2% nitric acid. The solution was analyzed using ICP-OES and no other cations or sulfate was found in the solution, indicating a high purity of Li₂CO₃ product.

TABLE 3
Simulation parameters for anion exchange process
System and operation parameters

| L (cm) | ID (cm) | Particle radius (μm) | Flow rate (mL/min) | ε_{b} | εₚ |
|---|---|---|---|---|---|
| 120 | 2.5 | 320 | 2.5 | 0.35 | 0.45 |

Isotherm parameters (Constant separation factor, qₘₐₓ = 0.7 meq/mL)

| Component | | α_{i, 1} |
|---|---|---|
| 1 | OH⁻ | 1 |
| 2 | SO₄²⁻ | 5 |
| 3 | Li | 0 |
| 4 | NH₄⁺ | 0 |

Mass transfer parameters

| | Brownian | Pore | Axial dispersion | Film mass transfer |
|---|---|---|---|---|
| | diffusivity, D_{b} | diffusivity, | coefficient, E_{b} | coefficient, k_{f} |
| Component | (cm²/min) | Dₚ (cm²/min) | (cm²/min) | (cm/min) |
| All species | 4 × 10⁻⁴ | 5 × 10⁻⁵ | Chung and Wen | Wilson and |
| | | | (1968) | Geankoplis (1966) |

Numerical parameters (unit: N)

| Axial | Step size | Collocation points | | Tolerance | |
|---|---|---|---|---|---|
| element | (L/u₀) | Axial | Particle | Absolute | Relative |
| 151 | 0.01 | 4 | 2 | 10⁻⁴ | 10⁻³ |

### Example 6: Displacement Methods for the Separation and Purification of Li, Co, Ni, and Mn Derived from Waste LIBs

Three different examples are included in this section to demonstrate the displacement fractionation of metal ions from complex mixtures derived from waste lithium-ion batteries. Different sorbents, presaturants, feed compositions, displacers, and operating conditions were used and are summarized in Tables 4 and 5. A summary of the effluent histories of the three displacement examples is shown in FIG. 25. Simulation parameters are listed in Table 6, and a summary of yield and productivity can be found in Table 7. Each example is explained in detail below.

### Example 6.1

In this example, AmberSep IRC 748 UPS (IDA functional group) was used as the sorbent with ammonium ions as the presaturant. A dilute acid (0.5 N H₂SO₄) was used as the displacer. The fractionation process was designed based on the constant pattern displacement design method (Section V5). For the design parameters, pulse tests were used to estimate porosities, single component frontal test was used to estimate the sorbent capacity and diffusivity, binary mixture frontal tests were used to estimate selectivities. The composition of the feed solution was analyzed with ICP-OES.

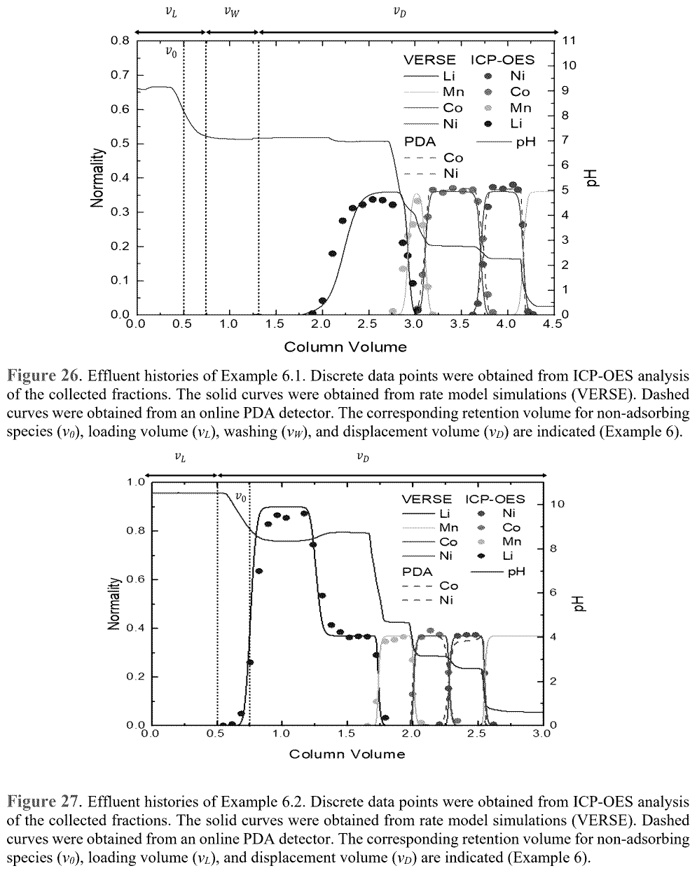

The effluent was collected in fractions and each fraction was analyzed with ICP-OES to determine the concentrations of Li, Mn, Co, and Ni. The concentrations of Co and Ni in the effluent was also monitored with an online photodiode array (PDA) detector. The concentration profiles from ICP-OES analysis are plotted as discrete points in FIG. 26. The PDA tracings were shown in dashed curves. The experimental effluent history is in close agreement with the simulated result validating the design method and the intrinsic parameters used in the design.

The effluent was also monitored using an online pH sensor. The pH profile of the effluent was plotted in FIG. 26 together with concentration profiles. Iminodiacetic acid is a weak acid with a pKa value of 1.83. When the IDA resin is presaturated with ammonium ions, the IDA functional groups tend to hydrolyze and adsorb hydrogen ions from water, resulting in a high pH (˜9) of the effluent after the resin was converted to ammonium form and washed before the feed loading.

When the feed (pH 3.0) containing divalent metal ions was introduced into the column, IDA functional groups chelate with divalent metal ions and reduces the effects of hydrolysis. The pH decreased from 9 to 7 at the end of feed loading. Half C.V. of DI water (pH 5.5) was used to wash the column to allow adsorption of the unbound ions in the feed in the column void volume.

As the displacer, 0.5 N H₂SO₄ (pH 0.3), was loaded into the column, the adsorbed metal ions started to be displaced by H⁺ ions, which has the highest affinity to the sorbent. The displacer displaces Ni, which in turn displaces Co, Mn, and Li. Eventually, a constant pattern isotachic train was formed and eluted from the column. As displacement bands of Mn, Co, and Ni exit the column, the effluent displays the pH of the metal sulfate salt solution, further lowers the effluent pH from 7 to below 4.

The nominal displacer concentration was 0.5 N while the displacement band formed only had a plateau concentration of 0.37 N. This reduction can be attributed to a higher sorbent capacity of H⁺ ions compared to the divalent metal ions.

### Example 6.2

In this example, Purolite Chromalite MIDA/C (IDA functional group, 200 μm particle diameter) was used as the sorbent with lithium ions as the presaturant. A dilute acid (0.5 N H₂SO₄) was used as the displacer.

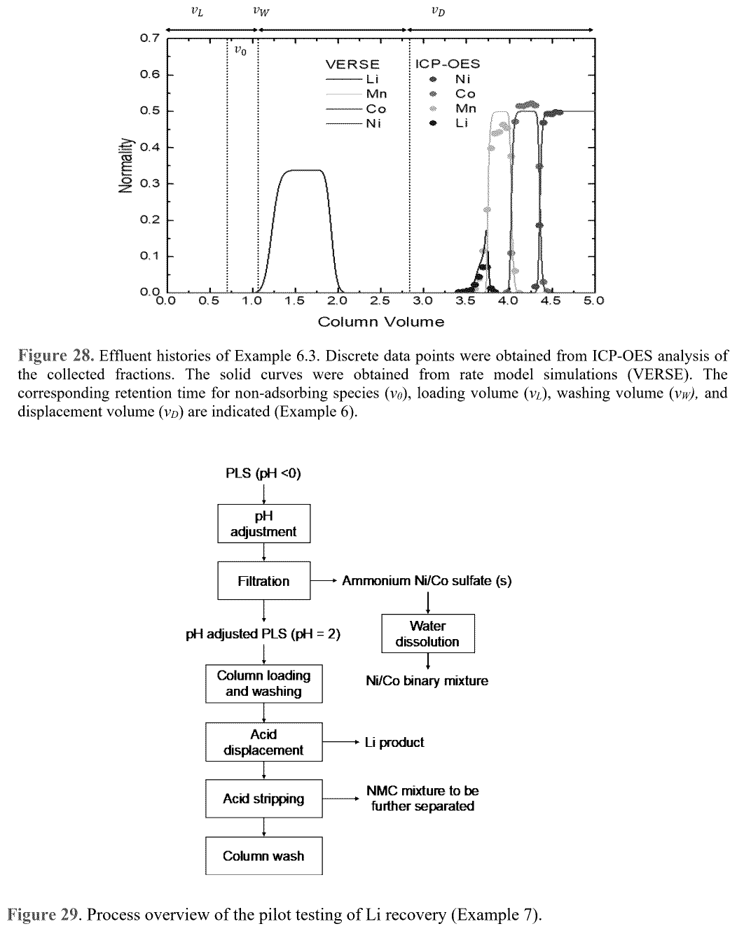

When the presaturant are Li ions, the Li ions in the feed can be considered as a non-adsorbing solute. When the feed was introduced into the column, presaturated Li ions were displaced by higher valence Mn, Co, and Ni ions, and eluted together with the Li ions in the feed at the void volume (FIG. 27). A total concentration of 0.9 N was observed in the effluent, which is consistent with the total feed concentration. When the displacer was introduced into the column, it displaced Ni, which in turn displaced Co, Mn, and any remaining Li. Eventually, a constant pattern isotachic train was formed. The experimental effluent history is in close agreement with the simulations.

Similar to Example 6.1, the displacement band concentration was 0.37 N when the nominal displacer concentration was 0.5 N, resulted from a higher capacity of H ions. The pH effluent history had the same trend as the one obtained during Example 6.1.

When Li ions are the presaturant, a high-purity Li sulfate product is collected in the effluent. No further separation of Li sulfate from the presaturant (NH₄⁺ or Na+) is needed.

### Example 6.3

In Example 6.3, Purolite Chromalite MIDA/C (IDA functional group, 200 μm particle diameter) was used as the sorbent with Na ions as the presaturant. Instead of a dilute acid, a nickel chloride solution (0.5 N) was used as the displacer.

After feed loading, a large volume (1.7 C.V.) of DI water was used in the washing step. The majority of Li eluted during this washing step, as shown in FIG. 28. Since the extended water wash facilitated the elution of Li, a lower apparent selectivity for Li was used in the simulation.

In Examples 6.1 and 6.2, H⁺ ions were the displacer, the displacement band concentrations were lower than the H⁺ displacer concentration, apparently because the sorbent capacity for H⁺ ions is higher than that of the displaced divalent ions. By contrast, when a nickel solution was used as the displacer in this example, the obtained displacement band concentrations were the same as the displacer concentration 0.5N, because the displaced ions and the displacer had the same capacity. Nickel solution as a displacer (Example 6.3) is less corrosive compared to acid solutions and can achieve higher displacement band concentration, higher product concentration, and higher sorbent productivity (Table 7). Examples 6.2 and 6.3 reached much higher sorbent productivities than Example 6.1, because the sorbent used in Examples 6.2 and 6.3 has a much smaller particle size, 200 microns, than the sorbent used in Example 6.1, 575 microns.

TABLE 4
Material and system parameters

| | Example 6.1 | Example 6.2 | Example 6.3 |
|---|---|---|---|
| Resin ¹ | IRC 748 | MIDA/C | MIDA/C |
| Capacity (meq/mL) | 0.88 | 0.5 | 0.5 |
| Particle diameter (um) | 575 | 200 | 200 |
| Column height (cm) | 175 | 82 | 36 |
| Column ID (cm) | 1.16 | 1.16 | 1.5 |
| Resin volume (mL) | 185 | 87 | 64 |
| εₜ | 0.54 | 0.74 | 0.74 |
| ε_{b} | 0.29 | 0.4 | 0.4 |
| εₚ | 0.35 | 0.56 | 0.57 |
| Asymmetric factor ² | 1.08 | 0.8 | 0.7 |
| Reduced HETP ² | 12.5 | 5.2 | 6.4 |
| Intraparticle pore diffusivity | 5e−5 | 5e−5 | 5e−5 |
| (cm²/min) | | | |

TABLE 5
Experiment conditions

| | | Example | Example | Example |
|---|---|---|---|---|
| | | 6.1 | 6.2 | 6.3 |
| Feed pH | | 3.0 | 2.5 | 4.0 |
| Feedstock composition (N) | Na | N/A | N/A | 0.985 |
| | Li | 0.33 | 0.30 | 0.225 |
| | Mn | 0.089 | 0.205 | 0.119 |
| | Co | 0.287 | 0.198 | 0.147 |
| | Ni | 0.211 | 0.203 | 0.131 |

| | | | |
|---|---|---|---|
| Presaturant | NH₄ | Li | Na |
| Displacer species | H₂SO₄ | H₂SO₄ | NiCl₂ |
| Displacer concentration (N) | 0.50 | 0.50 | 0.50 |
| Effective displacer | 0.37 | 0.37 | 0.50 |
| concentration (N) | | | |
| Loading volume (CV) | 0.76 | 0.5 | 1.12 |
| Washing volume (CV) | 0.50 | N/A | 1.68 |
| Displacer volume (CV) | 3.1 | 2.2 | 1.88 |
| Experiment flowrate (mL/min) | 0.3 | 0.45 | 0.6 |
| Interstitial velocity (cm/min) | 0.96 | 1.06 | 0.85 |

TABLE 6
Simulation parameters
Isotherm parameters (Constant separation factor isotherm)

| Component | | Example 6.1 | Example 6.2 | Example 6.3 |
|---|---|---|---|---|
| 1 | NH₄⁺ | 0.8 | N/A | N/A |
| 2 | Na⁺ | N/A | N/A | 0.2 |
| 3 | Li⁺ | 1.1 | 1 | 0.3 |
| 4 | Mn²⁺ | 4 | 3.8 | 3.8 |
| 5 | Co²⁺ | 16 | 15.2 | 15.2 |
| 6 | Ni²⁺ | 60 | 57.7 | 57.7 |
| 7 | H⁺ | 240 | 289 | 289 |

Mass transfer parameters

| | Brownian | Pore | Axial dispersion | | Film mass transfer |
|---|---|---|---|---|---|
| | diffusivity, D_{b} | diffusivity, | coefficient, | | coefficient, k_{f} |
| Component | (cm²/min) | Dₚ (cm²/min) | E_{b} (cm²/min) | | (cm/min) |
| All | 4 × 10⁻⁴ | 5 × 10⁻⁵ | Chung and Wen (1968) | | Wilson and |
| | | | | | Geankoplis (1966) |
| Axial | | Collocation points | | Tolerance | |
| element | Step size | Axial | Particle | Absolute | Relative |
| 151 | 0.01 | 4 | 2 | 1 × 10⁻⁵ | 1 × 10⁻⁴ |

TABLE 7
Yields and productivities for high-purity products and mixed products

| | | Example | Example | Example |
|---|---|---|---|---|
| | | 6.1 | 6.2 | 6.3 |
| Sorbent particle diameter (μm) | | 575 | 200 | 200 |
| Pure product fractions ³ | Li | 86% | 86% | 93% |
| | Mn | 0% | 75% | 57% |
| | Co | 75% | 77% | 70% |
| | Ni | 70% | 76% | 80% |
| Mixed products ⁴ | | 35% | 23% | 27% |
| Productivity(kg/m³ · | Li | 0.78 | 2.12 | 3.59 |
| day) ⁵ | Mn | 0.00 | 4.88 | 4.60 |
| | Co | 2.50 | 5.38 | 7.49 |
| | Ni | 1.71 | 5.29 | 7.59 |

| | | | |
|---|---|---|---|
| Total productivity (kg/m³ · day) | 4.98 | 17.68 | 23.27 |
| based on metal ions ⁵ | | | |

¹ DuPont: Ambersep 748, Purolite: Chromalite MIDA/C
² Tracer used was Blue Dextran
³ Mass percentage of isolated pure component based on the corresponding amount of compound that was fed.
⁴ Mass percentage of mixed bands out of the total feed.
⁵ Considering 2 hours of resin pretreatment, and calculating the kg as pure products (>99.5%) on a metal ion basis, without recycling the mixed bands.

### Example 7 Pilot Scale Testing of Lithium Purification from Lithium-Ion Battery Black Mass Pregnant Leaching Solution

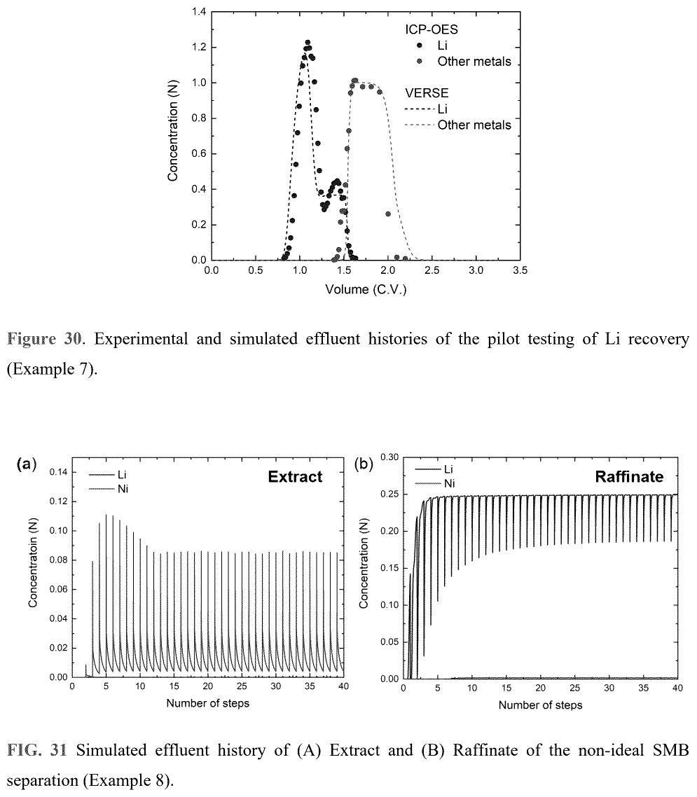

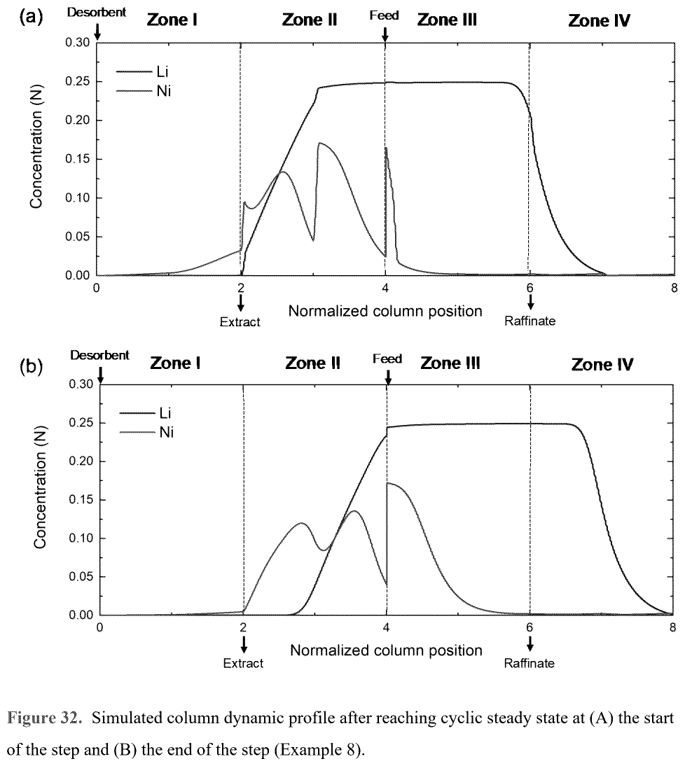

Seven gallons of pregnant leaching solution derived from lithium-ion battery black mass was mixed first to yield a mixture. The mixture had a high total metal ions concentration as well as a high acidity (>1 M acid). The pH of the mixture solution was adjusted to ˜2 by adding ammonium hydroxide solution (30%) to prevent corrosion of the stainless-steel piping and damage to the resin. A grayish green solid was formed during the pH adjustment step. The resulting slurry was filtered, and the resulting filtrate solution was used as the feed to the column. A pilot scale chromatography unit was used for the purification test. Three columns (each respective column being 1 m in length and 7.62 cm in diameter) were packed with a resin with IDA functional groups, AmberSep IRC748 UPS resin, which is the same resin tested in Example 6.1. The feed was loaded into the column at a high linear interstitial velocity, 16.87 cm/min. A minimum amount of water was used to flush all the feed remaining in the tubing into the column. A slow linear velocity (2.42 cm/min) was then adopted in the acid displacement step to collect high-purity Li products and a fast linear velocity (12.26 cm/min) was used to strip off other metal ions after all the Li has eluted. The process overview is shown in FIG. 29. The effluent history is shown in FIG. 30. Simulation parameters are shown in Table 8.

A yield of 99.9% pure Li product was 88%. The productivity achieved 6.81 kg/m³/day Li metal ion basis and 36.2 kg/m³/day Li carbonate basis. The collected Li fraction can produce up to 170 g of Li carbonate. The collected NMC fraction can be further separated into high purity metal salts.

TABLE 8
Simulation parameters for pilot testing

| | | | | | Feed | | | | |
|---|---|---|---|---|---|---|---|---|---|
| L | ID | R | | | volume | | | Feed | |
| (cm) | (cm) | (μm) | ε_{b} | εₚ | (L) | Flow rate (ml/min) | | concentration (N) | |
| 297.3 | 7.62 | 288 | 0.39 | 0.44 | 6 | Loading | 300 | NH₄⁺ | 1.5 |
| | | | | | | Washing | 300 | Li⁺ | 0.93 |
| | | | | | | Displacement | 43 | M²⁺ | 1.20 |
| | | | | | | Stripping | 218 | H⁺ | 0.1 |

Isotherm parameters (Constant separation factor isotherm)
qₘₐₓ = 0.9 meq./mL column volume

| Component | | Separation factor |
|---|---|---|
| 1 | NH₄⁺ | 1 |
| 2 | Li⁺ | 1 |
| 3 | Non- Li M²⁺ | 10 |
| 4 | H⁺ | 100 |

Mass transfer parameters

| | Brownian | Pore | | |
|---|---|---|---|---|
| | diffusivity, | diffusivity, | Axial dispersion | Film mass transfer |
| | D_{b} | Dₚ | coefficient, E_{b} | coefficient, k_{f} |
| Component | (cm²/min) | (cm²/min) | (cm²/min) | (cm/min) |
| ′Li | 4 × 10⁻⁴ | 2 × 10⁻⁴ | Chung and Wen | Wilson and |
| Other | 4 × 10⁻⁴ | 5 × 10⁻⁵ | (1968) | Geankoplis (1966) |

Numerical parameters

| Axial | Step | Collocation points | | Tolerance | |
|---|---|---|---|---|---|
| element | size | Axial | Particle | Absolute | Relative |
| 151 | 0.01 | 4 | 2 | 7 × 10⁻⁶ | 10⁻³ |

### Example 8 Isocratic 4-Zone SMB for the Separation of Li and Ni

AmberSep M4195 resin is used as the sorbent in this example. The bis-picolylamine functional groups in the stationary phase can strongly chelate with divalent metal ions such as Cu and Ni even at low pH (<2), while Li ions remain as a non-adsorbing species. The adsorbed metal ions can be eluted using a dilute sulfuric acid.

An isocratic 4-zone SMB based on AmberSep M4195 for the separation of Li and Ni is developed as explained below. Feed compositions are listed in Table 9.

TABLE 9
Composition of the binary mixture of Li and Ni

| Component | Li | Ni |
|---|---|---|
| Concentration (N) | 0.25 | 0.25 |

System parameters are listed in Table 10. The isotherm parameters were estimated from literature and resin product data sheet and are listed in Table 11.

TABLE 10
System parameters for the ideal SMB design

| | | | | | | Intraparticle |
|---|---|---|---|---|---|---|
| | | | Particle | | | diffusivity |
| L_{c} | Zone | Column | size | | | Dₚ |
| (cm) | configuration | diameter | Rₚ (μm) | ε_{b} | εₚ | (cm²/min) |
| 45 | 2-2-2-2 | 2.5 | 200 | 0.35 | 0.25 | 9 × 10⁻⁵ |

TABLE 11
Langmuir isotherm parameters for Li and Ni

| Component | Li | Ni |
|---|---|---|
| a | 0 | 3.75 |
| b (L/eq.) | 0 | 7.5 |

Effective retention factors for the standing components in the four zones for this non-linear adsorption isotherm system are:

$${δ}_{N i}^{I} = {ε}_{p} + ( 1 - {ε}_{p} ) {a}_{Ni}$$

$${δ}_{Li}^{II} = {ε}_{p} + ( 1 - {ε}_{p} ) \frac{{a}_{Li}}{1 + {b}_{Ni} {c}_{p , Ni}} = {ε}_{p}$$

$${δ}_{Ni}^{III} = {ε}_{p} + ( 1 - {ε}_{p} ) \frac{{a}_{Ni}}{1 + {b}_{Ni} {c}_{s , Ni}}$$

$${δ}_{Li}^{IV} = {ε}_{p} + ( 1 - {ε}_{p} ) \frac{{a}_{Li}}{1 + {b}_{Li} {c}_{p , Li}} = {ε}_{p}$$

The Standing Wave Design equations for the respective wave velocities in the four zones are given as:

$${u}_{w , Ni}^{I} = v = \frac{{u}_{0}^{I}}{1 + P {δ}_{Ni}^{I}} \\ {u}_{w , Li}^{II} = v = \frac{{u}_{0}^{II}}{1 + P {δ}_{Li}^{II}} \\ {u}_{w , Ni}^{I} = v = \frac{{u}_{0}^{III}}{1 + P {δ}_{Ni}^{III}} \\ {u}_{w , Li}^{IV} = v = \frac{{u}_{0}^{IV}}{1 + P {δ}_{Li}^{IV}}$$

### Feed Flow Rate:

$$\frac{{Q}_{feed}}{{ε}_{b} {A}_{c}} = {u}_{0}^{III} - {u}_{0}^{II}$$

Given a feed flow rate of 10 mL/min, the port velocity and the linear zone velocities can be calculated as

$$v = 2.37 cm / min \\ {u}_{0}^{I} = 15.83 cm / min \\ {u}_{0}^{II} = 3.46 cm / min \\ {u}_{0}^{III} = 9.28 cm / min \\ {u}_{0}^{IV} = 3.47 cm / min$$

### Switching Time:

$${t}_{sw} = \frac{{L}_{c}}{v} = \frac{45 cm}{2.37 cm / min} = 19 min$$

### Flowrate in Each Zone is:

$${Q}^{I} = 27.2 cm / min \\ {Q}^{II} = 5.95 cm / min \\ {Q}^{III} = 15.95 cm / min \\ {Q}^{IV} = 5.96 cm / min$$

For a non-ideal system, the Standing Wave Design equations are modified as:

$${u}_{w , Ni}^{I} = v + \frac{{β}_{Ni}^{I}}{( 1 + P {δ}_{Ni}^{I} ) {L}^{I}} [ {E}_{b , Ni}^{I} + \frac{P {{v}^{2} ( {δ}_{Ni}^{I} )}^{2}}{{K}_{f , Ni}^{I}} ] \\ {u}_{W , Li}^{II} = v + \frac{{β}_{Li}^{II}}{( 1 + P {δ}_{Li}^{II} ) {L}^{II}} [ {E}_{b , Li}^{II} + \frac{P {{v}^{2} ( {δ}_{Li}^{II} )}^{2}}{{K}_{f , Ni}^{II}} ] \\ {u}_{w , Ni}^{III} = v \\ {u}_{W , Li}^{IV} = v - \frac{{β}_{Li}^{IV}}{( 1 + P {δ}_{Li}^{IV} ) {L}^{IV}} [ {E}_{b , Li}^{IV} + \frac{P {{v}^{2} ( {δ}_{Li}^{IV} )}^{2}}{{K}_{f , Ni}^{IV}} ]$$

in which Bᵢ^{j} is the decay coefficient in each zone and is kept to be 9.21 to ensure a yield of greater than 99%, E_{b,i}^{j} is the axial dispersion coefficient, and K_{f,i}^{j} is the overall mass transfer coefficient is defined as

$$\frac{1}{{K}_{f , i}^{j}} = \frac{{R}_{p}^{2}}{15 {ε}_{p} {D}_{p}} + \frac{{R}_{p}}{3 {k}_{f}}$$

where k_{f} is the film mass transfer coefficient.

Notice that in Zone III, the wave velocity is set to be the port velocity and not corrected with mass transfer coefficients. This is because for a highly non-linear system, self-sharpening effects can balance the mass transfer effects and eventually form constant pattern frontal wave as long as column length is sufficiently long. The column length in the design is chosen so that the length of Zone III can contain the mass transfer length of the Ni adsorption wave.

The iterative calculation yields the operation parameters for the non-ideal design, listed in Table 12.

TABLE 12
Operation parameters for ideal and non-ideal SMBs

| Flow rates (mL/min) | Ideal Design | Non-ideal Design for M4195 |
|---|---|---|
| Feed | 10 | 10 |
| Raffinate | 10 | 10.1 |
| Desorbent | 21.5 | 181.0 |
| Extract | 21.5 | 180.9 |
| Port velocity (cm/min) | 2.37 | 2.37 |
| Extract Conc/Feed Conc. (Ni) | 0.46 | 0.055 |

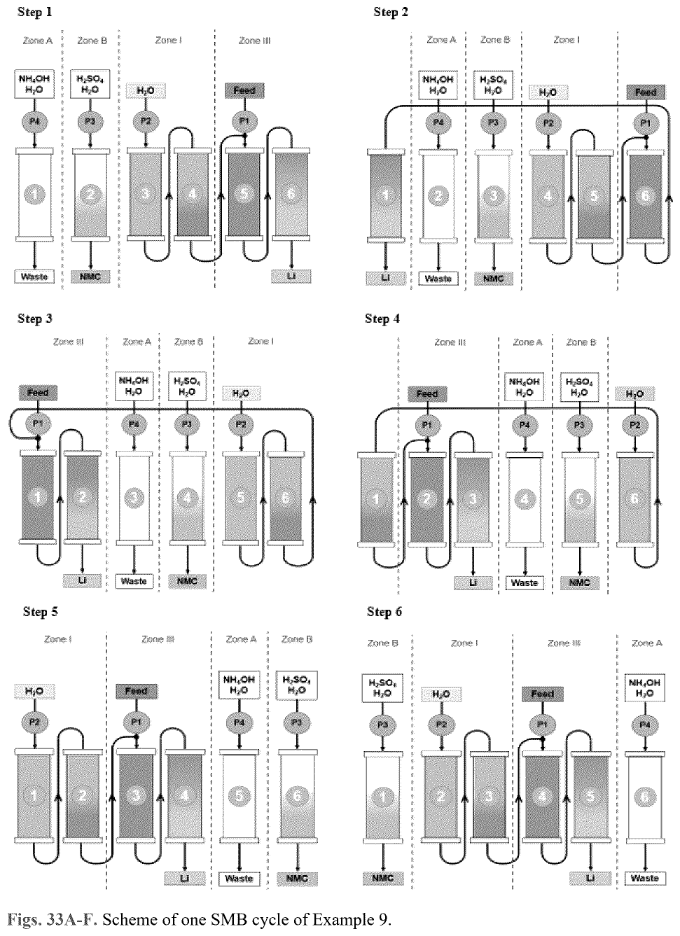

The simulated effluent history is shown in FIG. 31, and the column dynamic profiles at the beginning of the step and at the end of the step after reaching cyclic steady state are shown in FIGS. 32A and 32B, respectively. The purity and yield for both Li and Ni achieved >99%. The productivity of Li is 14.1 kg/m³/day (metal basis) or 74.9 kg/m³/day (Li carbonate basis).

In the substantially ideal design, which applies to systems without any substantial wave spreading, a large desorbent flow rate is needed to match the Ni desorption wave velocity in Zone I with the fast Li adsorption wave velocity in Zone III. As a result, the Ni concentration in the extract is diluted to about 46% of that in the feed. In the non-ideal design, which is based on the particle diameter of 400 microns of AmberSep M4195, the Ni desorption wave in Zone I (FIG. 32) is significantly spread due to intraparticle diffusion and axial dispersion at a high desorbent flow rate. Since the Zone length is fixed at 120 cm for both the ideal design and the non-ideal design, the desorbent flow rate needs to be increased to confine the Ni desorption wave in Zone I. As a result, the Ni concentration in the extract is only 5.5% of that of the feed (Table 12).

This example shows that for a high selectivity sorbent with a high Langmuir “a” value, if the slow migrating component has a much higher effective retention factor than the fast migrating solute, the extract product will be diluted significantly (5.5% of the Ni concentration in the feed in Example 8). This problem can be solved by designing a multi-zone SMB, in which the slow migrating solutes are desorbed in a separate stripping zone by using a strong stripping agent, as shown in Example 9.

### Example 9: Multi-Zone Simulated Moving Bed for the Continuous Splitting of Li from Nickel, Cobalt, and Manganese

In this example high purity Li product is continuously recovered from a complex mixture containing Li, Mn, Co, and Ni. A continuous chromatography system having four pumps and eight operationally connected columns was employed. Each column had four inlet ports and four outlet ports.

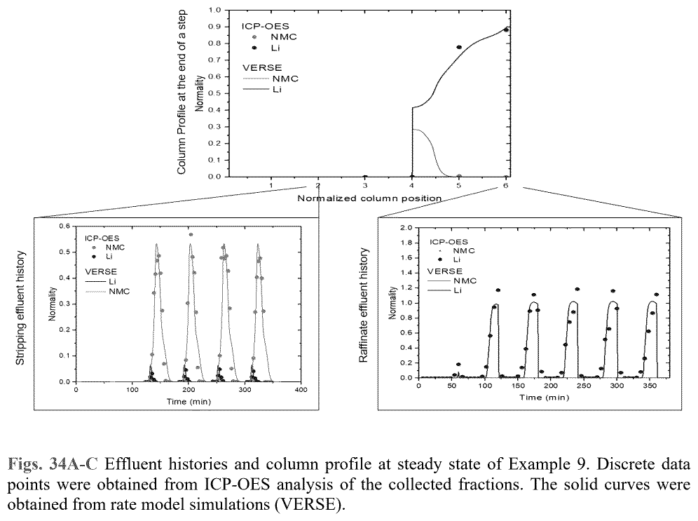

A four-zone SMB configuration was established in this example (see FIGS. 15G and 33). Six columns packed with AmberSep IRC748 UPS (IDA) resin were connected to the continuous chromatography system and were all converted into ammonium form (presaturant) before the experiment.

The feed solution was a simulant with a similar composition as that of the leaching solution of black mass derived from waste lithium-ion batteries, Example 7. Before the first step of SMB operation, the two columns in Zone III were pre-loaded with the feed solution to reduce the number of steps needed to achieve cyclic steady state. Water was used as the desorbent for Li and was introduced into Zone I, which enabled the weakly adsorbing Li to quickly migrate into Zone III and to be collected in the effluent of Zone III (raffinate). In the meantime, strongly adsorbing divalent Ni, Co, and Mn ions were retained in Zone I. Adsorbed Ni, Co, and Mn ions were stripped in Zone B using a dilute acid. Water was used to wash out the acid in Zone B after the complete stripping of metal ions. In Zone A columns were regenerated to ammonium form and washed with water. The complete regeneration and washing took 60 min, which established the average port velocity (0.5 cm/min) and the step time of 60 min.

Frontal simulations were carried out to establish the minimum flow rate required to fully wash the Li in the bulk out of Zone I for the given step time. Then, the feed flowrate was calculated using the standing wave design method. The ideal and nonideal designs as well as the detailed system and operating conditions are listed in Tables 13 to 16.

Six steps were run to confirm the SMB operation. Effluents from the raffinate port (outlet of Zone III) and the outlet of Zone B (stripped divalent metals) were analyzed using ICP-OES. Close agreement between the experimental and simulated effluent history validated the mSMB design method for selecting the operation parameters and the intrinsic parameters estimated form lab-scale tests. Cyclic steady state was reached within 6 steps, as a result of the novel pre-loading strategy.

The SMB test was able to achieve a yield of 97% for high purity Li (>99.9% pure). The productivity reached 16 kg Li ions/m³/day or 85 kg Li₂CO₃/m³/day. Mn, Co, and Ni were recovered as mixed sulfate salts with a yield of >70% and a purity of 99.9%. The mixture of Mn, Co, and Ni from this mSMB can be further separated with a second and a third mSMB in tandem, or with other novel fractionation methods as explained in previous examples, Examples 1 through 8.

TABLE 13
Material and system parameters

| Resin | | IRC 748 UPS |
|---|---|---|
| Capacity (meq/mL) | | 0.88 |
| Particle diameter (um) | | 575 |
| Column height (cm) | | 30.2 |
| Column ID (cm) | | 2.74 |
| Number of columns | | 6 |
| Step time (min) | | 60 |
| εₜ | | 0.62 |
| ε_{b} | | 0.39 |
| εₚ | | 0.40 |
| Feed pH | | 2.6 |
| Feedstock | NH₄ | 1.0 |
| composition | Li | 0.88 |
| (N) | Mn | 0.295 |
| | Co | 0.275 |
| | Ni | 0.167 |

TABLE 14
Estimated operation parameters for ideal and non-ideal cases

| Flow rates (mL/min) | Ideal Design | Non-ideal Design |
|---|---|---|
| Feed | 2.73 | 2.05 |
| Raffinate | 5.83 | 5.15 |

TABLE 15
Operating parameters for all the zones

| | ZONE A | ZONE B | ZONE I | ZONE III |
|---|---|---|---|---|
| Component | NH₄OH 1N | H₂SO₄ 1N | H₂O | Feed |
| | H₂O | H₂O | | |
| Flow rate (mL/min) | 11.9 | 11.9 | 3.1 | 2.0 |
| # Columns | 1 | 1 | 2 | 2 |

TABLE 16
Simulation parameters
Isotherm parameters (Multicomponent isotherm)

| Component | | a | b |
|---|---|---|---|
| 1 | NH₄⁺ | 44 | 50 |
| 2 | Li⁺ | 44 | 50 |
| 3 | NMC²⁺ | 880 | 1000 |

Mass transfer parameters

| | Brownian | Pore | Axial dispersion | Film mass transfer |
|---|---|---|---|---|
| | diffusivity, D_{b} | diffusivity, | coefficient, E_{b} | coefficient, k_{f} |
| Component | (cm²/min) | Dₚ (cm²/min) | (cm²/min) | (cm/min) |
| All | 4 × 10⁻⁴ | 5 × 10⁻⁵ | Chung and Wen (1968) | Wilson and |
| | | | | Geankoplis (1966) |

Numerical parameters

| Axial | | Collocation points | | Tolerance | |
|---|---|---|---|---|---|
| element | Step size | Axial | Particle | Absolute | Relative |
| 151 | 0.01 | 4 | 2 | 1 × 10⁻⁵ | 1 × 10⁻⁴ |

### Summary and Conclusions

As shown in the above Examples, the versatile and efficient multi-dimensional and multi-mode chromatography methods (FIG. 3) can be deployed to recover a single product or multiple products with high purities and high yields from multi-component mixtures. A brief summary of the potential applications of the new methods is given below.

Case 1: If only one target component is required to be recovered from a complex mixture (derived from brines, mineral ores, or waste LIBs), the following cases should be considered.
Case 1A. One should find a perfectly selective sorbent that adsorbs only the target or have a very high selectivity (>20) for the target for use in a capture process. The single-column (or batch) constant-pattern capture processes (FIG. 5A and Examples 1, 2, and 5) can be deployed to produce high purity (99%) product with a high yield. The target component will be recovered in the stripping or desorption zone. If a very high yield (>99%) of the product is desired, the batch capture method will not achieve a high sorbent utilization (<75%). A constant-pattern continuous carousel capture process (FIG. 9B, Example 4.1) should be deployed to achieve high yield (>99%) of the target, 100% sorbent utilization, and higher sorbent productivity than the batch capture processes.
Case 1B: If a sorbent with a very high selectivity for all the other components (impurities) in the feed mixture and it does not adsorb the target component, then this sorbent can be deployed in a batch capture process (similar to Example 1) or a continuous carousel capture process (similar to Example 4.1) to produce high purity target in the flow through stream, while the impurities will be removed in the stripping zone.

Case 1C: If a sorbent highly selective for the target or a sorbent highly selective for the impurities is unavailable, a sorbent with a moderate selectivity (>3) for either the target or the impurities can be deployed; a continuous isocratic 4-zone SMB (FIG. 4C) can be deployed to recover high purity target with high yield either in the Extract or in the Raffinate (FIG. 15A). If the target is the slow migrating component and it has a relatively high retention factor (>3), a non-isocratic 4-zone SMB should be deployed to recover a concentrated, pure target in the stripping zone and to reduce the amount of desorbent needed for the separation. In this case, an additional stripping zone is added to the separation zones and a stripping agent is used to remove quickly the strongly adsorbed solute in the stripping zone. The stripping agent can shorten the retention times of the strongly adsorbed solutes by changing mobile phase pH, solvent strength, ionic strength, or temperature, and can increase the sorbent productivity and product concentration.

Case 1D. Isotachic displacement method can be deployed to recover the target with high purity (Example 7). Two mixed bands may need to be recycled to achieve a high yield of the target.
Case 2: If two pure targets (for example Ni and Li) are required to be produced from a binary mixture of the two, the following options should be considered.
Case 2A: If a sorbent highly selective for one of the two targets (for example Ni over Li), with a selectivity greater than 10, is available, a batch capture process (FIG. 5A) or a carousel capture process (FIG. 9B) can be deployed to produce two high-purity products.
Case 2B: If a high-selectivity sorbent for the two targets is unavailable, an isocratic 4-zone SMB with a moderate selectivity (>2) can be deployed to produce both products with high purities (99%) and high yields (99%). If the slow migrating component has a relatively high retention factor (>3), a 4-zone non-isocratic SMB (FIG. 15H, Example 9) can be deployed to recover a concentrated Extract product and both products will have high purities and high yields.
Case 3. If three targets (for example, Li, Ni, Co) are required to be produced with high purities and high yields from a ternary mixture of the three, the following cases should be considered.
Case 3A: If a highly selective sorbent for each target is available, a constant-pattern tandem capture process (FIG. 8, Example 3) or a constant-pattern tandem carousel process (FIG. 22) can be deployed to produce high purity products with high yields and high sorbent productivity.
Case 3B. If perfectly selective sorbents for the three targets are unavailable, a sorbent with good selectivity (>2) for all three targets is available, a 4-zone isocratic SMB (FIG. 15C) can be deployed to produce the two high-selectivity targets in the Extract, and the low selectivity target in the Raffinate. A second 4-zone SMB can be deployed in tandem to produce the target with the highest selectivity in the Extract and the second-high selectivity target in the Raffinate (similar to FIG. 15B). If the sorbent for the second SMB has a high retention factor (>3), a non-isocratic 4-zone SMB (FIG. 15H, Example 9) can be deployed to produce high purity products.
Case 3C. A 4-zone non-isocratic SMB can be deployed to recover the lowest selectivity target (for example Li) in the Raffinate and the higher selectivity targets (for example Ni and Co) in the Extract (Example 9). The Extract (a binary mixture) can be further separated in a batch capture process based on a sorbent which is highly selective for one of the two targets (FIG. 5A), or a carousel capture process based on the same sorbent (FIG. 9B).
Case 3D. An isotachic displacement process can be deployed to produce three high purity products (for example, Ni, Co, and Li) with high purities and high yields, similar to Example 6.
Case 4. If four targets (for example, Li, Ni, Co, and Mn) are required to be produced from a mixture of the four, the following cases should be considered.
Case 4A. If a perfectly selective sorbent for each target or three of the four targets is available, the constant-pattern tandem capture method (Example 3), or the constant-pattern tandem carousel capture method (FIG. 22) are preferred.
Case 4B. If perfectly selective sorbents for the targets are unavailable, a 4-zone isocratic SMB can be deployed to recover the lowest selectivity target (for example Li) in the Raffinate and a mixture of the other three targets (for example Ni, Co, and Mn) in the Extract (similar to Example 8). The ternary mixture of the three targets can be further separated to produce high purity products as explained in Case 3.
Case 4C. A 4-zone isocratic SMBs can be deployed as the first step to split the four targets into two fractions (for example, Ni and Co in the Extract and Mn and Li in the Raffinate, FIG. 15D). A second isocratic 4-zone SMB can be deployed to separate the Raffinate mixture (for example, Mn and Li) from the first SMB to produce pure products (similar to FIG. 15A). In parallel, a third isocratic 4-zone SMB can be deployed to separate the Extract from the first SMB (for example, Ni and Co) to produce pure products. Alternatively, instead of the third isocratic 4-zone SMB, a non-isocratic 4-zone SMB (similar to FIG. 15H or Example 9) can be deployed to recover the highest selectivity target (for example, Ni) in the stripping zone and the other target (for example, Co) in the Raffinate.
Case 4D. A 4-zone non-isocratic 4-zone SMB can be deployed first to recover the lowest selectivity target (for example, Li) in the Raffinate and the other three targets (for example, Ni, Co, and Mn) as a mixture in the stripping zone (Example 9). The ternary mixture can be further fractionated as discussed in Case 3.
Case 4E. Isotachic displacement method can be deployed to produce four high-purity products (for example, Li, Ni, Co, and Mn) from a 4-component mixture, as shown in Example 6. Case 4F. Isotachic displacement method can be deployed to produce a high-purity product (in the early elution fraction, for example Li) and a mixture of the other three targets (for example, Ni, Co, and Mn) in the late elution fraction, as explained in Example 7, FIG. 30. The mixture of the three targets (Ni, Co, and Mn) can be further separated as discussed in Case 3.
Case 5. If four pure products (for example, Li, Ni, Co, and Mn) are required to be produced from a complex mixture of the four components, plus an impurity (for example, Fe⁺³), the following cases are discussed below.
Case 5A. If a perfectly selective sorbent for the impurity (Fe⁺³) is available, it can be deployed in a constant-pattern batch capture process (FIG. 5A, similar to Example 1) or a carousel capture process (FIG. 9B, similar to Example 4) to remove the impurity (Fe⁺³) from the feed mixture. The 4-component mixture (for example, Li, Ni, Co, and Mn) can be further purified as explained in Case 4.
Case 5B. If no perfect selective sorbent for Fe⁺³ is available, a sorbent with a good selectivity (>5) for Fe⁺³ can be deployed in a non-isocratic 8-zone SMB, FIG. 15F, to recover Fe⁺³ in the stripping zone, the lowest selectivity target (for example, Li) from the raffinate, and a mixture of the other targets (for example, Ni, Co, and Mn) in the Extract. The Extract (a ternary mixture) can be further separated as explained in Case 3. If the 8-zone SMB equipment is unavailable, a non-isocratic 4-zone SMB (FIG. 15H, similar to Example 9) can be deployed to remove the impurity.
In conclusion, if only one product is required to be produced from a complex mixture, a constant-pattern batch capture method or a carousel capture method is preferred. If a high-selectivity sorbent to capture the target is unavailable, isocratic or non-isocractic SMB methods or isotachic displacement method, can be deployed. If two or more products are required to be produced from complex mixtures, the capture methods or the fractionation methods, 4-zone SMB or multi-zone SMB, are required. In general, the versatile and efficient capture methods (single column or carousel capture), tandem capture, tandem carousel capture, isocratic SMB, isocratic tandem SMB, and non-isocractic 4-zone or multi-zone SMB methods can be deployed in tandem or in parallel to produce high purity products with high yields and high productivity.

### Advantages of the New Methods

These new methods can all achieve high purity (>99.5%) products, either all four elements as a group or individual four elements, with high yields (>99%) from complex mixtures. Impurities were effectively removed to ppm levels, before further purification or direct precipitation, crystallization, or electrowinning. Compared to state-of-the-art purification methods, these methods have compact processing volume, small footprint, and high productivity. New purification methods only use safe and mild chemicals in ambient temperature and low-pressure equipment, which leads to low capital and energy costs as well as increased safety. Only Na or ammonium salts are generated in the process and can be recycled to acid and base again. The methods are applicable to N component mixtures and the products can be individual elements or any combination of mixtures of Li, Mn, Co, and Ni. They are highly efficient and flexible for processing feedstocks with different compositions and different production scales.

While the invention has been illustrated and described in detail in the drawings and foregoing description, the same is to be considered as illustrative and not restrictive in character. It is understood that the embodiments have been shown and described in the foregoing specification in satisfaction of the best mode and enablement requirements. It is understood that one of ordinary skill in the art could readily make a nigh-infinite number of insubstantial changes and modifications to the above-described embodiments and that it would be impractical to attempt to describe all such embodiment variations in the present specification. Accordingly, it is understood that all changes and modifications that come within the spirit of the invention are desired to be protected.

I claim:

1. A method for continuously recovering a high purity material from a complex mixture, comprising:
a) preparing a complex mixture containing metallic elements Q, X, Y, and Z;
b) introducing the complex mixture into a chromatography system having four pumps and at least four operationally connected columns, wherein each respective column has a plurality of inlet ports and a plurality of outlet ports;
c) establishing a four-zone simulated moving bed configuration with six respective columns packed with resin to define Zones A, B, I, and III and two columns pre-loaded with feed solution to define Zone III;
d) introducing a feed solution or a simulant;
e) introducing a desorbent for Q into Zone I to urge weakly adsorbing Q to migrate into Zone III for collection in the effluent of Zone III;
f) retaining strongly adsorbing X, Y, and Z ions in Zone I;
g) stripping adsorbed X, Y, and Z ions in Zone B with a dilute acid;
h) washing out the acid in Zone B after the complete stripping of metal ions; and
i) regenerating columns defining Zone A.

2. The method of claim 1 wherein the chromatography system has four pumps and eight operationally connected columns, wherein each respective column has at least four inlet ports and at least four outlet ports.

3. The method of claim 1, and further comprising:
j) extracting effluents from a Zone III outlet port; and
k) verifying that Q extracted from the Zone III outlet port is in excess of 99% pure.

4. The method of claim 1 and further comprising repeating steps a-i until a steady-state is reached.

5. The method of claim 4 wherein steady-state is achieved in 6 repetitions of steps a-i.

6. The method of claim 1 wherein Q is lithium, X is cobalt, Y is nickel, and Z is manganese.

7. The method of claim 1 wherein the chromatography system has six pumps and twelve operationally connected columns, wherein each respective column has at least four inlet ports and at least four outlet ports; and wherein a six-zone simulated moving bed configuration is established.

8. A method for separating target elements Li, Co, Ni, and Mn in a mixture derived from waste LIBs or other feedstocks, comprising:
a) physically separating carbon black and graphite in black mass from metal oxides;
b) acid leaching of the metal oxides to yield metal salts in a feed solution;
c) flowing the feed solution into a series of operationally connected columns, including a first column containing a sorbent with high selectivity for impurities and a second column containing sorbents with high selectivity for the separation of predetermined elements, wherein the second column is presaturated with ions selected from the group consisting of lithium ions and nonlithium ions with low affinity for the sorbents;
d) capturing at least one impurity within the first column;
e) displacing lithium with manganese in the second column;
f) displacing manganese with cobalt in the second column;
g) displacing cobalt with nickel in the second column; and
h) displacing nickel with a displacer having a high selectivity for the sorbent in the second column.

9. The method of claim 8 wherein the at least one impurity is selected from the group consist of aluminum, iron, and copper ions.

10. A method using a single column for capture of a target lithium-ion battery component element or an impurity from waste lithium-ion batteries or other feedstocks, comprising:
a) providing a chromatography column having a first predetermined diameter and a second predetermined length;
b) positioning resin in the chromatography column for capturing metal ions, wherein the resin is selected from the group consisting of resins having a high selectivity for one of the lithium-ion battery component metal ions and resins having a high selectivity for one of the lithium ion battery impurity metal ions;
c) pre-saturating the chromatography column with weakly adsorbing species;
d) flowing a solution of metal salts leached from waste lithium-ion batteries through the chromatography column; and
e) establishing a constant pattern of the captured target in the chromatography column;
wherein the predetermined column length is sufficient to allow formation of a constant pattern of the target element.

11. The method of claim 10 and further comprising:
f) removing the captured target element from the column by using a stripping agent,
g) flowing the effluent of the first column to a second column packed with a resin with a high selectivity for a second target element and repeating steps from a) to f).

12. A method using a carousel for capturing a target element from mixtures of lithium-ion battery elements and impurities or other feedstocks, comprising:
a) providing a first, a second, and a third respective chromatography column;
b) positioning resin in the respective chromatography columns for capturing a predetermined metal ion;
c) flowing a solution of metal salts leached from waste lithium-ion batteries through the first chromatography column and into the second chromatography column;
d) when the concentration of the predetermined metal ion in the solution of metal salts exiting the first chromatography column reaches a predetermined limit, the solution of metal salts is flowed through the second column into the third column while the first column is isolated from the second and third columns and stripped with a dilute acid;
e) when the concentration of the predetermined metal ion in the solution of metal salts exiting the second chromatography column reaches the predetermined limit, the solution of metal salts is flowed through the third column into the first column while the second column is isolated from the first and third columns and stripped with a dilute acid;
f) when the concentration of the predetermined metal ion in the solution of metal salts exiting the third chromatography column reaches the predetermined limit, the solution of metal salts is flowed through the first column into the second column while the third column is isolated from the first and second columns and stripped with a dilute acid; and
g) steps d) through f) are repeated until the solution of metal salts is depleted.

13. A tandem capture method for recovering multiple target components sequentially from waste LIBs or other feedstocks, comprising:
a) providing a first, a second, and a third respective chromatography column assembly;
b) positioning a first resin in the first chromatography column assembly for capturing a first predetermined metal ion component;
c) positioning a second resin in the second chromatography column assembly for capturing a second predetermined component;
d) positioning a third resin in the third chromatography column assembly for capturing a third predetermined component;
e) flowing a solution of metal salts leached from waste lithium-ion batteries or other feedstocks through the first chromatography column assembly to capture the first predetermined target component;
f) flowing effluent from the first chromatography column assembly through the second chromatography column assembly to capture the second predetermined target component;
g) flowing effluent from the second chromatography column assembly through the third chromatography column assembly to capture the third predetermined target component; and
h) extracting any remaining component from the effluent exiting the third column assembly.

14. The method of claim 13 wherein each respective column assembly defines a respective carousel system defining multiple columns.

15. The method of claim 13 wherein at last one respective column assembly defines a respective carousel system defining multiple columns.

16. An anion exchange method for yielding high purity LiOH, comprising:
a) providing a chromatography column containing an anion exchange resin and pre-equilibrated with OH;
b) flowing high purity lithium salt solution through the chromatography column; and
c) flowing high purity LiOH effluent out of the chromatography column.

17. The method of claim 16, wherein the single column defines a carousel system.

18. A method for recovering metal ions from waste materials, comprising:
a) identifying a chromatography assembly having three operationally connected columns, wherein each respective column is filled with resin;
b) identifying a predetermined quantity of pregnant leaching solution derived from lithium-ion battery black mass defining a mixture, wherein the mixture defines a total metal ion concentration and a high acidity in excess of 1 M;
c) adjusting the pH of the mixture to about 2 to prevent equipment degradation;
d) forming a solid during pH adjustment to define a slurry;
e) filtering the slurry to recover a filtrate solution;
f) using the filtrate solution as column feed;
g) loading column feed into a respective column at a first linear velocity;
h) displacing the column feed with acid at a second, slower linear velocity to collect high-purity Li products;
i) stripping other metal ions after elution of the lithium at a third faster linear velocity faster than the second linear velocity;
wherein the other metal ions are selected from the group comprising nickel, manganese and cobalt.

19. The method for recovering metal ions from waste materials of claim 18 and further comprising:
j) collecting other metal ions; and
k) separating nickel, manganese, and cobalt, respectively, from one another;
wherein the separated nickel, manganese, and cobalt ions are present in the form of high purity salts.
